SEQUENCE LISTING (48 sequences)

SEQ ID NO: 1 - DNA, 2341 bp, Influenza A virus
agcgaaagcaggtcaattatattcaatatggaaagaataaaagaactaagaaatctaatgtcgcagtctcgcacccgcgagatactcacaaaaaccaccgtggaccatatggccataatcaagaagtacacatcaggaagacaggagaagaacccagcacttaggatgaaatggatgatggcaatgaaatatccaattacagcagacaagaggataacggaaatgattcctgagagaaatgagcaaggacaaactttatggagtaaaatgaatgatgccggatcagaccgagtgatggtatcacctctggctgtgacatggtggaataggaatggaccaatgacaaatacagttcattatccaaaaatctacaaaacttattttgaaagagtcgaaaggctaaagcatggaacctttggccctgtccattttagaaaccaagtcaaaatacgtcggagagttgacataaatcctggtcatgcagatctcagtgccaaggaggcacaggatgtaatcatggaagttgttttccctaacgaagtgggagccaggatactaacatcggaatcgcaactaacgataaccaaagagaagaaagaagaactccaggattgcaaaatttctcctttgatggttgcatacatgttggagagagaactggtccgcaaaacgagattcctcccagtggctggtggaacaagcagtgtgtacattgaagtgttgcatttgactcaaggaacatgctgggaacagatgtatactccaggaggggaagtgaagaatgatgatgttgatcaaagcttgattattgctgctaggaacatagtgagaagagctgcagtatcagcagacccactagcatctttattggagatgtgccacagcacacagattggtggaattaggatggtagacatccttaagcagaacccaacagaagagcaagccgtgggtatatgcaaggctgcaatgggactgagaattagctcatccttcagttttggtggattcacatttaagagaacaagcggatcatcagtcaagagagaggaagaggtgcttacgggcaatcttcaaacattgaagataagagtgcatgagggatatgaagagttcacaatggttgggagaagagcaacagccatactcagaaaagcaaccaggagattgattcagctgatagtgagtgggagagacgaacagtcgattgccgaagcaataattgtggccatggtattttcacaagaggattgtatgataaaagcagttagaggtgatctgaatttcgtcaatagggcgaatcagcgactgaatcctatgcatcaacttttaagacattttcagaaggatgcgaaagtgctttttcaaaattggggagttgaacctatcgacaatgtgatgggaatgattgggatattgcccgacatgactccaagcatcgagatgtcaatgagaggagtgagaatcagcaaaatgggtgtagatgagtactccagcacggagagggtagtggtgagcattgaccggttcttgagagtccgggaccaacgaggaaatgtactactgtctcccgaggaggtcagtgaaacacagggaacagagaaactgacaataacttactcatcgtcaatgatgtgggagattaatggtcctgaatcagtgttggtcaatacctatcaatggatcatcagaaactgggaaactgttaaaattcagtggtcccagaaccctacaatgctatacaataaaatggaatttgaaccatttcagtctttagtacctaaggccattagaggccaatacagtgggtttgtgagaactctgttccaacaaatgagggatgtgcttgggacatttgataccgcacagataataaaacttcttcccttcgcagccgctccaccaaagcaaagtagaatgcagttctcctcatttactgtgaatgtgaggggatcaggaatgagaatacttgtaaggggcaattctcctgtattcaactacaacaaggccacgaagagactcacagttctcggaaaggatgctggcactttaaccgaagacccagatgaaggcacagctggagtggagtccgctgttctgaggggattcctcattctgggcaaagaagacaggagatatgggccagcattaagcatcaatgaactgagcaaccttgcgaaaggagagaaggctaatgtgctaattgggcaaggagacgtggtgttggtaatgaaacgaaaacgggactctagcatacttactgacagccagacagcgaccaaaagaattcggatggccatcaattagtgtcgaatagtttaaaaacgaccttgtttctact

SEQ ID NO: 2 - DNA, 2341 bp, Influenza A virus
agcgaaagcaggcaaaccatttgaatggatgtcaatccgaccttacttttcttaaaagtgccagcacaaaatgctataagcacaactttcccttataccggagaccctccttacagccatgggacaggaacaggatacaccatggatactgtcaacaggacacatcagtactcagaaaaggcaagatggacaacaaacaccgaaactggagcaccgcaactcaacccgattgatgggccactgccagaagacaatgaaccaagtggttatgcccaaacagattgtgtattggaagcaatggctttccttgaggaatcccatcctggtatttttgaaaactcgtgtattgaaacgatggaggttgttcagcaaacacgagtagacaagctgacacaaggccgacagacctatgactggactttaaatagaaaccagcctgctgcaacagcattggccaacacaatagaagtgttcagatcaaatggcctcacggccaatgagtctggaaggctcatagacttccttaaggatgtaatggagtcaatgaaaaaagaagaaatggggatcacaactcattttcagagaaagagacgggtgagagacaatatgactaagaaaatgataacacagagaacaataggtaaaaggaaacagagattgaacaaaaggagttatctaattagagcattgaccctgaacacaatgaccaaagatgctgagagagggaagctaaaacggagagcaattgcaaccccagggatgcaaataagggggtttgtatactttgttgagacactggcaaggagtatatgtgagaaacttgaacaatcagggttgccagttggaggcaatgagaagaaagcaaagttggcaaatgttgtaaggaagatgatgaccaattctcaggacaccgaactttctttgaccatcactggagataacaccaaatggaacgaaaatcagaatcctcggatgtttttggccatgatcacatatatgaccagaaatcagcccgaatggttcagaaatgttctaagtattgctccaataatgttctcaaacaaaatggcgagactgggaaaagggtatatgtttgagagcaagagtatgaaacttagaactcaaatacctgcagaaatgctagcaagcattgatttgaaatatttcaatgattcaacaagaaagaagattgaaaaaatccgaccgctcttaatagaggggactgcatcattgagccctggaatgatgatgggcatgttcaatatgttaagcactgtattaggcgtctccatcctgaatcttggacaaaagagatacaccaagactacttactggtgggatggtcttcaatcctctgacgattttgctctgattgtgaatgcacccaatcatgaagggattcaagccggagtcgacaggttttatcgaacctgtaagctacatggaatcaatatgagcaagaaaaagtcttacataaacagaacaggtacatttgaattcacaagttttttctatcgttatgggtttgttgccaatttcagcatggagcttcccagttttggtgtgtctgggagcaacgagtcagcggacatgagtattggagttactgtcatcaaaaacaatatgataaacaatgatcttggtccagcaacagctcaaatggcccttcagttgttcatcaaagattacaggtacacgtaccgatgccatagaggtgacacacaaatacaaacccgaagatcatttgaaataaagaaactgtgggagcaaacccgttccaaagctggactgctggtctccgacggaggcccaaatttatacaacattagaaatctccacattcctgaagtctgcctaaaatgggaattgatggatgaggattaccaggggcgtttatgcaacccactgaacccatttgtcagccataaagaaattgaatcaatgaacaatgcagtgatgatgccagcacatggtccagccaaaaacatggagtatgatgctgttgcaacaacacactcctggatccccaaaagaaatcgatccatcttgaatacaagtcaaagaggagtacttgaagatgaacaaatgtaccaaaggtgctgcaatttatttgaaaaattcttccccagcagttcatacagaagaccagtcgggatatccagtatggtggaggctatggtttccagagcccgaattgatgcacggattgatttcgaatctggaaggataaagaaagaagagttcactgagatcatgaagatctgttccaccattgaagagctcagacggcaaaaatagtgaatttagcttgtccttcatgaaaaaatgccttgttcctact

SEQ ID NO: 3 - DNA, 2233 bp, Influenza A virus
agcgaaagcaggtactgatccaaaatggaagattttgtgcgacaatgcttcaatccgatgattgtcgagcttgcggaaaaaacaatgaaagagtatggggaggacctgaaaatcgaaacaaacaaatttgcagcaatatgcactcacttggaagtatgcttcatgtattcagatttccacttcatcaatgagcaaggcgagtcaataatcgtagaacttggtgatcctaatgcacttttgaagcacagatttgaaataatcgagggaagagatcgcacaatggcctggacagtagtaaacagtatttgcaacactacaggggctgagaaaccaaagtttctaccagatttgtatgattacaaggaaaatagattcatcgaaattggagtaacaaggagagaagttcacatatactatctggaaaaggccaataaaattaaatctgagaaaacacacatccacattttctcgttcactggggaagaaatggccacaaaggccgactacactctcgatgaagaaagcagggctaggatcaaaaccaggctattcaccataagacaagaaatggccagcagaggcctctgggattcctttcgtcagtccgagagaggagaagagacaattgaagaaaggtttgaaatcacaggaacaatgcgcaagcttgccgaccaaagtctcccgccgaacttctccagccttgaaaattttagagcctatgtggatggattcgaaccgaacggctacattgagggcaagctgtctcaaatgtccaaagaagtaaatgctagaattgaaccttttttgaaaacaacaccacgaccacttagacttccgaatgggcctccctgttctcagcggtccaaattcctgctgatggatgccttaaaattaagcattgaggacccaagtcatgaaggagagggaataccgctatatgatgcaatcaaatgcatgagaacattctttggatggaaggaacccaatgttgttaaaccacacgaaaagggaataaatccaaattatcttctgtcatggaagcaagtactggcagaactgcaggacattgagaatgaggagaaaattccaaagactaaaaatatgaaaaaaacaagtcagctaaagtgggcacttggtgagaacatggcaccagaaaaggtagactttgacgactgtaaagatgtaggtgatttgaagcaatatgatagtgatgaaccagaattgaggtcgcttgcaagttggattcagaatgagttcaacaaggcatgcgaactgacagattcaagctggatagagcttgatgagattggagaagatgtggctccaattgaacacattgcaagcatgagaaggaattatttcacatcagaggtgtctcactgcagagccacagaatacataatgaagggggtgtacatcaatactgccttacttaatgcatcttgtgcagcaatggatgatttccaattaattccaatgataagcaagtgtagaactaaggagggaaggcgaaagaccaacttgtatggtttcatcataaaaggaagatcccacttaaggaatgacaccgacgtggtaaactttgtgagcatggagttttctctcactgacccaagacttgaaccacacaaatgggagaagtactgtgttcttgagataggagatatgcttctaagaagtgccataggccaggtttcaaggcccatgttcttgtatgtgaggacaaatggaacctcaaaaattaaaatgaaatggggaatggagatgaggcgttgtctcctccagtcacttcaacaaattgagagtatgattgaagctgagtcctctgtcaaagagaaagacatgaccaaagagttctttgagaacaaatcagaaacatggcccattggagagtctcccaaaggagtggaggaaagttccattgggaaggtctgcaggactttattagcaaagtcggtatttaacagcttgtatgcatctccacaactagaaggattttcagctgaatcaagaaaactgcttcttatcgttcaggctcttagggacaatctggaacctgggacctttgatcttggggggctatatgaagcaattgaggagtgcctaattaatgatccctgggttttgcttaatgcttcttggttcaactccttccttacacatgcattgagttagttgtggcagtgctactatttgctatccatactgtccaaaaaagtaccttgtttctact

SEQ ID NO: 4 - DNA, 1565 bp, Influenza A virus
agcaaaagcagggtagataatcactcactgagtgacatcaaaatcatggcgtcccaaggcaccaaacggtcttacgaacagatggagactgatggagaacgccagaatgccactgaaatcagagcatccgtcggaaaaatgattggtggaattggacgattctacatccaaatgtgcacagaacttaaactcagtgattatgagggacggttgatccaaaacagcttaacaatagagagaatggtgctctctgcttttgacgaaaggagaaataaatacctggaagaacatcccagtgcggggaaggatcctaagaaaactggaggacctatatacagaagagtaaacggaaagtggatgagagaactcatcctttatgacaaagaagaaataaggcgaatctggcgccaagctaataatggtgacgatgcaacggctggtctgactcacatgatgatctggcattccaatttgaatgatgcaacttatcagaggacaagggctcttgttcgcaccggaatggatcccaggatgtgctctctgatgcaaggttcaactctccctaggaggtctggagccgcaggtgctgcagtcaaaggagttggaacaatggtgatggaattggtcaggatgatcaaacgtgggatcaatgatcggaacttctggaggggtgagaatggacgaaaaacaagaattgcttatgaaagaatgtgcaacattctcaaagggaaatttcaaactgctgcacaaaaagcaatgatggatcaagtgagagagagccgggacccagggaatgctgagttcgaagatctcacttttctagcacggtctgcactcatattgagagggtcggttgctcacaagtcctgcctgcctgcctgtgtgtatggacctgccgtagccagtgggtacgactttgaaagagagggatactctctagtcggaatagaccctttcagactgcttcaaaacagccaagtgtacagcctaatcagaccaaatgagaatccagcacacaagagtcaactggtgtggatggcatgccattctgccgcatttgaagatctaagagtattgagcttcatcaaagggacgaaggtggtcccaagagggaagctttccactagaggagttcaaattgcttccaatgaaaatatggagactatggaatcaagtacacttgaactgagaagcaggtactgggccataaggaccagaagtggaggaaacaccaatcaacagagggcatctgcgggccaaatcagcatacaacctacgttctcagtacagagaaatctcccttttgacagaacaaccgttatggcagcattcactgggaatacagaggggagaacatctgacatgaggaccgaaatcataaggatgatggaaagtgcaagaccagaagatgtgtctttccaggggcggggagtcttcgagctctcggacgaaaaggcagcgagcccgatcgtgccttcctttgacatgagtaatgaaggatcttatttcttcggagacaatgcagaggagtacgacaattaaagaaaaatacccttgtttctact

SEQ ID NO: 5 - DNA, 1027 bp, Influenza A virus
agcgaaagcaggtagatattgaaagatgagtcttctaaccgaggtcgaaacgtacgttctctctatcatcccgtcaggccccctcaaagccgagatcgcacagagacttgaagatgtctttgcagggaagaacaccgatcttgaggttctcatggaatggctaaagacaagaccaatcctgtcacctctgactaaggggattttaggatttgtgttcacgctcaccgtgcccagtgagcgaggactgcagcgtagacgctttgtccaaaatgcccttaatgggaacggggatccaaataacatggacaaagcagttaaactgtataggaagctcaagagggagataacattccatggggccaaagaaatctcactcagttattctgctggtgcacttgccagttgtatgggcctcatatacaacaggatgggggctgtgaccactgaagtggcatttggcctggtatgtgcaacctgtgaacagattgctgactcccagcatcggtctcataggcaaatggtgacaacaaccaacccactaatcagacatgagaacagaatggttttagccagcactacagctaaggctatggagcaaatggctggatcgagtgagcaagcagcagaggccatggaggttgctagtcaggctaggcaaatggtgcaagcgatgagaaccattgggactcatcctagctccagtgctggtctgaaaaatgatcttcttgaaaatttgcaggcctatcagaaacgaatgggggtgcagatgcaacggttcaagtgatcctctcgctattgccgcaaatatcattgggatcttgcacttgatattgtggattcttgatcgtctttttttcaaatgcatttaccgtcgctttaaatacggactgaaaggagggccttctacggaaggagtgccaaagtctatgagggaagaatatcgaaaggaacagcagagtgctgtggatgctgacgatggtcattttgtcagcatagagctggagtaaaaaactaccttgtttctact

SEQ ID NO: 6 - DNA, 890 bp, Influenza A virus
agcaaaagcagggtgacaaagacataatggatccaaacactgtgtcaagctttcaggtagattgctttctttggcatgtccgcaaacgagttgcagaccaagaactaggtgatgccccattccttgatcggcttcgccgagatcagaaatccctaagaggaaggggcagcactcttggtctggacatcgagacagccacacgtgctggaaagcagatagtggagcggattctgaaagaagaatccgatgaggcacttaaaatgaccatggcctctgtacctgcgtcgcgttacctaaccgacatgactcttgaggaaatgtcaagggaatggtccatgctcatacccaagcagaaagtggcaggccctctttgtatcagaatggaccaggcgatcatggataaaaacatcatactgaaagcgaacttcagtgtgatttttgaccggctggagactctaatattgctaagggctttcaccgaagagggagcaattgttggcgaaatttcaccattgccttctcttccaggacatactgctgaggatgtcaaaaatgcagttggagtcctcatcggaggacttgaatggaatgataacacagttcgagtctctgaaactctacagagattcgcttggagaagcagtaatgagaatgggagacctccactcactccaaaacagaaacgagaaatggcgggaacaattaggtcagaagtttgaagaaataagatggttgattgaagaagtgagacacaaactgaaggtaacagagaatagttttgagcaaataacatttatgcaagccttacatctattgcttgaagtggagcaagagataagaactttctcatttcagcttatttaataataaaaaacacccttgtttctact

SEQ ID NO: 7 - DNA, 1748 bp, Influenza A virus
gggaaaataaaaacaaccaaaatgaaagtaaaactactgatcctgttatgtacatttacagctacatatgcagacacaatatgtataggctaccatgccaacaactcaaccgacactgttgacacagtacttgagaagaatgtgacagtgacacactctgtcaacctacttgaggacagtcacaatggaaaactgtgcctactaaaaggaatagcccccctacaattgggtaattgcagcgttgccggatggatcttaggaaacccagaatgcgaattactgatttccaaggaatcatggtcctacattgtagaaacaccaaatcctgagaatggagcatgttacccagggtatttcgccgactatgaggagctaagggagcaattgagttcagtatcttcatttgagagattcgaaatattccccaaagaaagctcatggcccaaccacaccgtaaccggagtatcagcatcatgctcccataatgggaaaagcagtttttacagaaatttgctatggctgacggggaagaatggtttgtacccaaacctgagcaagtcctatgcaaacaacaaaaagaaagaagtccttatactatggggtgttcatcacccgcctaacataggggaccaaaggaccctctatcacacagaaaatgcttatgtctctgtagtgtcttcacattatagcagaagattcaccccagaaataaccaaaaggcccaaagtaagagatcaggaaggaagaatcaactactactggactctgctggaacccggggatacaataatatttgaggcaaatggaaatctaatagcgccatggtatgctttcgcactgagtagaggctttggatcaggaatcatcacctcaaatgcaccaatggatgaatgtgatgcgaagtgtcaaacacctcagggagctataaacagcagtcttcctttccagaatgtacacccagtcacaataggagagtgtccaaagtatgtcaggagtgcaaaattaaggatggttacaggactaaggaacatcccatccattcaatccagaggtttgtttggagccattgccggtttcattgaaggggggtggactggaatggtagatgggtggtatggttatcatcatcagaatgagcaaggatctggctatgctgcagatcaaaaaagcacacaaaatgccattaacgggattacaaacaaggtgaattctgtaattgagaaaatgaacactcaattcacagctgtgggcaaagaattcaacaaattggaaagaaggatggaaaacttaaataaaaaggttgatgatgggtttctagacatttggacatataatgcagaattgttggttctactggaaaatgaaaggactttggatttccacgactccaatgtgaagaatctgtacgagaaagtaaaaagccaattaaagaataatgccaaagaaataggaaatgggtgttttgaattctatcacaagtgtaacaatgaatgcatggagagtgtgaaaaatggaacttatgactatccaaaatattccgaagaatcaaagttaaacagggaaaaaattgatggagtgaaattggactcaatgggggtctatcagattctggcgatctactcaactgtcgccagttccctggttcttttggtctccctgggggcaatcagcttctggatgtgttccaatgggtctttgcagtgtagaatatgcatctgagaccaaaatttcagaaatataagaaaaaa

SEQ ID NO: 8 - DNA, 1773 bp, Influenza A virus
agcaaaagcaggggttataccatagacaaccaaaagcataacaatggccatcatttatctcatactcctgttcacagcagtgaggggggaccagatatgcattggataccatgccaataattccacagaaaaggtcgacacaattctagagcggaatgtcactgtgactcatgccaaggacatccttgagaagacccataacggaaagctatgcaaactaaacggaatccctccacttgaactaggggactgtagcattgccggatggctccttggaaatccagaatgtgataggcttctaagtgtgccagaatggtcctatataatggagaaagaaaacccgagatacagtttgtgttacccaggcagcttcaatgactatgaagaattgaaacatctcctcagcagcgtgaaacattttgagaaagttaagattttgcccaaagatagatggacacagcatacaacaactggaggttcatgggcctgcgcggtgtcaggtaaaccatcattcttcaggaacatggtctggctgacacgtaaaggatcaaattatccggttgccaaaggatcgtacaacaatacaagcggagaacaaatgctaataatttggggagtgcaccatcctaatgatgaggcagaacaaagagcattgtaccagaatgtgggaacctatgtttccgtagccacatcaacattgtacaaaaggtcaatcccagaaatagcagcaaggcctaaagtgaatggactaggacgtagaatggaattctcttggaccctcttggatatgtgggacaccataaattttgagagcactggtaatctagttgcaccagagtatgggttcaaaatatcgaaaagaggtagttcagggatcatgaagacagaaggaacacttgagaactgtgaaaccaaatgccaaactcctttgggagcaataaatacaacactaccttttcacaatgtccacccactgacaataggtgaatgccccaaatatgtaaaatcggagaaattggtcttagcaacaggactaaggaatgttccccagattgaatcaagaggattgtttggggcaatagctggttttatagaaggaggatggcaaggaatggttgatggttggtatggataccatcacagcaatgaccagggatcagggtatgcagcagacaaagaatccactcaaaaggcatttaatggaatcaccaacaaggtaaattctgtgattgaaaagatgaacacccaatttgaagctgttgggaaagaattcagtaacttagagaaaagactggagaacttgaacaaaaagatggaagacgggtttctagatgtgtggacatacaatgcagagcttctagttctgatggaaaatgagaggacacttgactttcatgattctaatgtcaagaatctgtatgataaagtcagaatgcagctgagagacaacgtcaaagaactaggaaatggatgttttgaattttatcacaaatgtgacaatgaatgcatggatagtgtgaaaaacgggacatatgattatcccaagtatgaagaagaatctaaactaaatagaaatgaaatcaaaggggtaaaattgagcagcatgggggtttatcaaatccttgccatttatgctacagtagcaggttctctgtcactggcaatcatgatggctgggatctctttctggatgtgctccaacgggtctctgcagtgcagaatctgcatatgattgtaagtcattttataattaaaaacacccttgtttcctga

SEQ ID NO: 9 - DNA, 1737 bp, Influenza A virus
ggataattctattaaccatgaagactatcattgctttgagctacattttgtgtctggttttcgctcaaaaacttcccgtaaatgacaacagcacggcaacgctgtgcctgggacaccatgcagtgccaaacggaacgctagtgaaaacaatcacgaatgaccacattgaagtgactaatgctactgagctggttcagagttcctcaacaggtagaatatgcgacagtcctcaccaaatccttgatggagaaaactgcacactaatagatgctctattgggagaccctcattgtgatggcttccaaaataaggaatgggacctttttgttgaacgcagcacagcctacagcaactgttacccttatgatgtgccggattatgcctcccttaggtcactagttgcctcatccggcacactggagtttaacaatgaaagcttcaattggactggagtcgctcagaatggaacaagctctgcttgcaaaaggagatctattaaaagtttctttagtagattgaattggttgcaccaattaaaatacaaatatccagcactgaacgtgactatgccaaacaatgaaaaatttgacaaattgtacatttggggggttcaccacccgagtacggacagtgaccaaatcagcctatatgctcaagcatcagggagagtcacagtctctaccaaaagaagccaacaaactgtaatcccgaatatcggatctagaccctgggtaaggggtgtctccagcagaataagcatctattggacaatagtaaaaccgggagacatacttttgattaacagcacagggaatctaattgctcctcggggttacttcaaaatacgaagtgggaaaagctcaataatgaggtcaaatgcacccattggcaaatgcaattctgaatgcatcactccaaatggaagcattcccaatgacaaaccatttcaaaatgtaaacaggatcacatatggggcctgtcccagatatgttaagcaaaacactctgaaattggcaacagggatgcggaatgtaccagagaaacaaactagaggcatattcggcgcaatcgcgggtttcatagaaaatggttgggaaggaatggtggacggttggtacggtttcaggcatcaaaattctgagggcacaggacaagcagcagatcttaaaagcactcaagcagcaatcaaccaaatcaacgggaaactgaataggttaatcgagaaaacaaacgagaaattccatcaaattgaaaaagaattctcagaagtagaagggagaattcaggacctcgagaaatatgttgaggacactaaaatagatctctggtcgtacaacgcggagcttcttgttgccctggagaaccaacatacaattgatctaactgactcagaaatgaacaaactgtttgaaagaacaaggaagcaactgagggaaaatgctgaggatatgggcaatggttgtttcaaaatataccacaaatgtgacaatgcctgcatagggtcaatcagaaatggaacttatgaccatgatgtatacagagacgaagcattaaacaaccggtttcagatcaaaggtgttgagctgaagtcaggatacaaagattggatcctatggatttcctttgccatatcatgttttttgctttgtgttgttttgctggggttcatcatgtgggcctgccaaaaaggcaacattaggtgcaacatttgcatttgagtgcagtaattaaaaacac

SEQ ID NO: 10 - DNA, 1695 bp, Influenza A virus
atgctatcaattgtgattttgtttctgctcatagcagagaactcttcccaaaactacacaggaaaccctgtgatatgcatgggacatcatgctgtggccaatgggactatggtaaagaccctagccgatgatcaagtggaagtggtcactgcacaggaactggtagaatcacaaaatctcccggaactatgtccgagccctctgagactagttgacggccagacctgtgatatcatcaatggagcattggggagcccagggtgtgaccatttgaatggtgcagaatgggacgttttcatagagaggcccaatgcagtagacacttgctatccatttgatgtgccagagtaccagagtctgagaagcatactcgccaacaatgggaaattcgaattcattgccgaagaattccaatggaacacggtgaagcaaaatggaaaatccggagcctgcaagagggcaaatgtggatgatttctttaacaggctaaactggctggtgaagtcagatgggaatgcgtacccccttcagaatttgacaaagataaacaatggggattatgcaaggctttacatctggggagttcatcacccttcgacaagcacagagcaaaccaacctgtacaagaataaccctggaagagtcactgtgtctaccaaaactagtcaaacaagtgtagtgcctgacattggcagcagacccttggtgagaggacaaagtggcagagtgagtttctactggactattgtagagcctggagacttgatagtcttcaacacaatagggaatctaattgccccgagaggccattacaagttaaacaatcagaagaagagcacaattctaaatactgcaattcccataggctcatgtgtcagcaaatgtcacacagacaaaggttctctctctacaactaagcccttccaaaatatctcgaggatagcagttggagactgccccagatatgtcaaacagggctctctaaaacttgcaacagggatgaggaacattcctgaaaaggcatcaagagggctttttggagcaatagctgggttcatagagaatggctggcaaggtctaatcgatggttggtatggattcagacaccagaatgcagaaggaacaggaacagcggcagatctcaaatccactcaggcagccattgatcaaatcaatgggaaacttaaccgtcttattgagaagacaaacgataaataccatcaaatcgaaaaagagttcgagcaagttgaaggaagaattcaagatctggaaaactatgttgaggacacaaagattgatttatggtcatataatgcagagctattagtcgctctagaaaaccaacacactatagacgtgactgattcagaaatgaacaaactctttgaaagagtaaggcgtcaactcagagagaatgctgaagacaaagggaatgggtgtttcgaaatattccacaagtgtgataacaactgcattgaaagtattcggaatgggacttatgatcatgatatttatagagatgaagcaatcaacaatcgattccaaatccagggagtcaaattgacccagggatataaggacatcattctttggatttcattctccatatcatgctttttgctcgtagcactacttttagccttcattttgtgggcttgtcagaacggaaacatccggtgccagatttgtatttag

SEQ ID NO: 11 - DNA, 1776 bp, Influenza A virus
agcaaaagcaggggttcaatctgtcaaaatggagaaaatagtgcttctttttgcaatagtcagtcttgttaaaagtgatcagatttgcattggttaccatgcaaacaactcgacagagcaggttgacacaataatggaaaagaacgttactgttacacatgcccaagacatactggaaaagacacacaacggaaagctctgcgatctagatggagtgaagcctctaattttgagagattgtagtgtagctggatggctcctcggaaacccaatgtgtgacgaattcatcaatgtgccggaatggtcttacatagtggagaaggccaatccagtcaatgatctctgttacccaggggatttcaatgactatgaagaattgaaacacttattgagcagaataaaccattttgagaaaattcagatcatccccaaaagttcttggctcagtcatgaagcctcattaggggtgagctcagcatgtccataccagggaaagtcctcctttttcagaaatgtggtatggcttatcaaaaagaacagtacatacccaacaataaagaggagctacaataacaccaaccaagaagatctgttggtactgtgggggattcaccatcctaatgatgcggcagagcagacaaagctctatcaaaacccaaccacctatatttccgttgggacatcaacactaaaccagagattggtaccaagaatagctactagatccaaagtaaacgggcaaagtggaaggatggagttcttctggacaattttaaaaccgaatgatgcaatcaatttcgagagtaatggaaatttcattgccccagaatatgcatacaaaattgtcaagaaaggggactcaacaattatgaaaagtgaattggaatatggtaactgcaacaccaagtgtcaaacaccaatgggggcgataaattctagtatgccattccacaatatacaccctctcaccatcggggaatgccccaaatatgtgaaatcaaacagattagtccttgcgactgggctcagaaatagccctcaaagagagagaagaaaaaagagaggattatttggagctatagcaggttttatagagggaggatggcagggaatggtagatggttggtatgggtaccaccatagcaatgagcaggggagtgggtacgctgcagacaaagaatccactcaaaaggcaatagatggagtcaccaataaggtcaactcgatcattgacaaaatgaacactcagtttgaagccgttggaagggaatttaacaacttagaaaggagaatagagaatttaaacaagaagatggaagacgggttcctagatgtctggacttataatgctgaacttctggttctcatggaaaatgagagaactctagactttcatgactcaaatgtcaagaacctttacgacaaggtccgactacagcttagggataatgcaaaggagctgggtaacggttgtttcgagttctatcataaatgtgataatgaatgtatggaaagtgtaagaaacggaacgtatgactacccgcagtattcagaagaagcaaaactaaaaagaggggaaataagtggagtaaaattggaatcaataggaatttaccaaatactgtcaatttattccacagtagcgagttccctagcactggcaatcatggtagctggtctatccttatggatgtgctccaatgggtcgttacaatgcagaatatgcatttagatttgtgaattcagattgtagttaaaaacacccttgtttctact

SEQ ID NO: 12 - DNA, 1701 bp, Influenza A virus
atgattgcaatcattgtagtagcgatactggcaacagccggaaggtctgacaagatctgcattggatatcatgccaacaattcaacaacacaaatagacacgatacttgagaagaatgtaactgtcacgcactcagttgagttgctggagaaccaaaaggaggaaagattctgcaagatcttgaaaaaggcccctcttgacctaaaaggatgtaccattgagggttggatcttgggaaatccccaatgtgatctattactaggtgaccagagctggtcatacatagtggaaagacctacagctcaaaatggaatttgctacccaggagttttgaatgaagtagaagaactgaaggcacttattggctcaggagaaagagtagaaagatttgaaatgttccccaaaagtacgtggacaggagtagacaccagtagtggggtaacaagagcttgcccatataacagtggttcatctttctacaggaacctcttatggataataaaaaccaagtcagcagcatattcagtaattaagggggcttataacaacacaggaaaccagccaatcctctatttttggggtgttcaccatcctcctgacactaatgagcaaaacactttgtatggctctggtgatcgatatgtcagaatggggactgaaagcatgaattttgccaagagcccagaaattgcagcaaggcccgctgtgaatggtcaaagaggcagaattgactattattggtctattttgaagccaggagaaaccttgaatgtggaatccaatgggaatctaattgccccttggtatgcgttcagatttgtcagcaccagtaacaaaggagctgtcttcaaatcaaatttaccaatcgagaattgtgatgccacatgccagactgttgcaggagtcctaaggaccaataaaacatttcagaatgtaagccctctgtggataggagaatgccccaaatatgtaaaaagtgaaagtctaagacttgcaactggattaagaaatgttccgcaaattgaaactagaggacttttcggagctatagcaggattcattgaaggaggatggactggaatgatagatggatggtacggctatcatcatgaaaattcacaaggctcaggttatgcagcagacagagaaagcactcagaaggctgtcgatggaattacaaataaggtcaattccattatagacaaaatgaacacacaattcgaagctgtagatcatgaattttccaatctggaaaggagaattgacaatctaaacaaaagaatggaagatggatttctggatgtctggacctacaacgctgaactgttggttcttcttgaaaacgaaagaacactagacctgcatgacgcaaatgtgaagaacctgtatgaaagagttaaatcacaactaagggacaatgccatgatcttggggaatggatgttttgaattctggcataagtgtgacgatgaatgtatggagtctgtcaagaatggtacctatgactatcctaaataccaggatgaaagcaaattaaacaggcaggaaatagaatcggtaaagctagagagccttggtgtctatcaaatccttgctatttatagtacggtatcgagcagtctggtcttggtagggctgatcatagcagtgggtctttggatgtgttcaaatggttcaatgcagtgcaggatatgtatataa

SEQ ID NO: 13 - DNA, 1684 bp, Influenza A virus
atgaacactcaaatcctggtattcgctctggtggcgatcattccgataaatgcagacaagatctgccttgggcatcatgccgtgtcaaacgggactaaagtaaacacattaactgaaagaggagtggaagtcgttaatgcaactgaaacggtggaacgaacaaacgtccccaggatctgctcaagagggaaaaggacagttgacctcggtcaatgtggacttctgggaacaatcactgggcccccccaatgtgaccaattcctagaattttcagccgatttaattattgagaggcgagaaggaagtgatgtctgttaccctggaaaattcgtgaatgaagaagctctgaggcaaattctcagggagtcaggcgggatcgacaaggagacaatgggattcacctacagcggaataagaactaatggagcaacaaatgcatgtaggagatcaggatcttcattctatgcagagatgaaatggctcctgtcaaacacagacaatgctgcttttccacagatgactaagtcatacaaaaacacaaggaaggacccagccctgataatatgggggatccaccattctggatcaactacagaacagaccaagctatatgggagtggaaacaaactgataacagtagggagttccaattaccaacagtcctttgtaccgagtccaggagcgagaccacaagtgaatggccaatccggaagaattgactttcattggctgatactaaaccccaatgacacagttactttcagtttcaatggggccttcatagctccagaccgtgcaagctttctgagagggaagtctatgggaattcagagtggagtacagattgatgccaattgtgaaggagattgctatcatagtggagggacaataataagtaacttgccctttcagaacataaatagcagggcagtaggaaaatgtccgagatatgttaagcaagagagtctgctgctggcaacaggaatgaagaatgttcccgaaatcccaaagggaagaggcctatttggtgctatagcgggtttcattgaaaacggatgggaaggtctgattgatgggtggtatggcttcaggcatcaaaatgcacaaggggagggaactgctgcagattacaaaagcacccaatcagcaattgatcaaataacaggaaaattaaaccggctcatagaaaaaactaaccaacaatttgagttaatagacaatgaattcactgaggttgaaaagcaaattggcaatgtgataaattggaccagagattccatgacagaagtgtggtcctataacgctgaactcttggtagcaatggagaatcagcacacaattgatctggccgactcagaaatgaacaagctgtacgaacgagtgaagagacaactgagagagaatgctgaagaagatggcactggttgcttcgaaatatttcacaaatgtgatgacgactgtatggccagtattagaaacaacacctatgatcacagcaagtacagagaagaggcaatgcaaaatagaatacagattgacccagtcaaactaagcagcggctacaaagatgtgatactttggtttagcttcggggcatcatgcttcatacttctagccattgcaatgggccttgtcttcatgtgtgtgaagaatggaaacatgcggtgcactatttgtatataag

SEQ ID NO: 14 - DNA, 1698 bp, Influenza A virus
atggaaaaattcatcgcaatagcaaccttggcgagcacaaatgcatacgataggatatgcattgggtaccaatcaaacaactccacagacacagtgaacactctcatagaacagaatgtaccagtcacccaaacaatggagctcgtggaaacagagaaacatcccgcttattgtaacactgatttaggtgccccattggaactgcgagactgcaagattgaggcagtaatctatgggaaccccaagtgtgacatccatctgaaggatcaaggttggtcatacatagtggagaggcccagcgcaccagaagggatgtgttaccctggatctgtggaaaatctagaagaactgaggtttgtcttctccagtgctgcatcttacaagagaataagactatttgactattccaggtggaatgtgactagatctggaacgagtaaagcatgcaatgcatcaacaggtggccaatccttctataggagcatcaattggttgaccaaaaaggaaccagacacttatgacttcaatgaaggagcttatgttaataatgaagatggagacatcattttcttatgggggatccatcatccgccggacacaaaagagcagacaacactatataaaaatgcaaacactttgagtagtgttactactaacactataaacagaagctttcaaccaaatattggtcccagaccattagtaagaggacagcaagggaggatggattactattggggcattctgaaaagaggggagactctgaagatcaggaccaacggaaatttaatcgcacctgaatttggctatctgctcaaaggtgaaagctacggcagaataattcaaaatgaggatatacccatcgggaactgtaacacaaaatgtcaaacatatgcgggagcaatcaatagcagcaaaccctttcagaatgcaagtaggcattacatgggagaatgtcccaaatatgtgaagaaggcaagcttgcgacttgcagttgggcttaggaatacgccttctgttgaacccagaggactgtttggagccattgctggtttcattgaaggaggatggtctggaatgattgatgggtggtatggatttcatcacagcaattcagagggaacaggaatggcagctgaccagaaatcaacacaagaagccatcgataagatcaccaataaagtcaacaatatagttgacaagatgaacagggagtttgaagttgtgaatcatgagttctctgaagttgaaaaaagaataaacatgataaacgataaaatagatgaccaaattgaagatctttgggcttacaatgcagagctccttgtgctcttagagaaccagaaaacgctagacgaacatgattccaatgtcaaaaacctttttgatgaagtgaaaaggagactgtcagccaatgcaatagatgctgggaacggttgctttgacatacttcacaaatgcgacaatgagtgtatggaaactataaagaacggaacttacgatcataaggaatatgaagaggaggctaaactagaaaggagcaagataaatggagtaaaactagaagagaacaccacttacaaaattcttagcatttacagtacagtggcggccagtctttgcttggcaatcctgattgctggaggtttaatcctgggcatgcaaaatggatcttgtagatgcatgttctgtatttga

SEQ ID NO: 15 - DNA, 1683 bp, Influenza A virus
atggaaacaatatcactaataactatactactagtagtaacggtaagcaatgcagataaaatctgcatcggctaccaatcaacaaactccacagaaactgtagacacgctaacagaaaacaatgttcctgtgacacatgccaaagaattactccacacagagcacaatgggatgctgtgtgcaacaaatctgggacgtcctctcattctagacacctgtaccattgaaggactgatctatggcaacccttcttgtgatctactgttgggaggaagagaatggtcctacatcgttgaaagaccatcggctgttaatggaatgtgttaccccgggaatgtagaaaatctagaggaactaagatcactctttagttctgctagttcctaccaaagaatccagatctttccagacacaatctggaatgtgtcttacagtggaacaagcaaagcatgttcagattcattctacaggagcatgagatggttgactcaaaaggacaacgattaccctattcaagacgcccaatacacaaataatagaggaaagagcattcttttcatgtggggcataaatcacccacccaccgatactacacagacaaatctgtacacaaggactgacacaacaacaagtgtggcaacagaggaaataaataggaccttcaaaccattgatagggccaaggccccttgtcaatggtcagcaggggagaattgattattattggtcagtattgaaaccaggtcagacattgcgagtaagatccaatgggaatctaatcgctccatggtatggacacattctttcaggagagagccatggaagaatcctgaagactgatttaaaaagtggtaactgtgtagtgcaatgtcagacagaaagaggtggcttaaatactacattgccattccacaatgtcagtaaatatgcatttggaaactgcccaaaatatgttggagtaaagagtctcaaactggcagttggtctgaggaatgtgcctgctagatcaagtagaggactatttggggccatagctggattcatagagggagggtggtcagggctagtcgctggtgggtatgggttccagcactcaaatgatcaagggggtggtatggctgcagatagagaatcaactcaaaaggcaattgacaaaataacatccaaagtgaataatatagtcgataaaatgaacaaacaatatgaaattattgatcatgaattcagcgaggttgaagcaggactcaatattcccaaaaataagattgatgaccacattcaagacatatgggcatataacgcagaattgctagtgctgcttgaaaaccagaaaacactcgatgagcatgatgcgaatgtaaacaatctatataacaaagtgaagagggcactgggttccaatgcaatggaagatgggaaaggatgtttcgagctataccataaatgtgatgatcagtgcatggagacaattcggaacgggacctatagcaggagaaagtataaagaggaatcaagactagaaagacagaaaatagaaggggtcaagctggaatctgaaggaacttacaaaatcctcactatttattcgactgtcgcctcatctcttgtgattgcaatggggtttgctgccttccttttctgggccatgtccaatggatcttgcagacgcaacatttgtatatag

SEQ ID NO: 16 - DNA, 1727 bp, Influenza A virus
agcaaaagcaggggtcacaatgtacaaagtagtagtaataattgcgctccttggagcagtgaaaggtcttgacagaatctgcctaggacaccatgcggttgccaatggaaccattgtgaagacccttacaaatgaacaagaggaagtgaccaatgctactgagacggtagagagcacaaatttgaataaattgtgtatgaaaggaagaagctacaaggacttgggcaattgtcacccggtaggaatgttgataggaacacctgtttgtgatccgcacttgaccgggacctgggacactctcattgagcgagagaatgccattgcccactgttatccaggggcaaccataaatgaagaagcattgaggcagaaaataatggaaagtggaggaatcagcaagatgagcactggcttcacttatgggtcttccatcacctcagctgggaccactaaggcatgcatgagaaatggaggagatagtttctatgcagagctcaaatggctagtgtcaaagacaaagggacaaaatttccctcagacaacaaacacctatcggaatacggacacagcagaacatctcataatatggggaattcatcacccttccagcacacaggaaaagaatgacttatacggaactcagtcactatctatatcagttgagagttctacatatcagaacaactttgttccagttgttggggcaagacctcaggtcaatggacaaagtgggcgaattgactttcactggacactagtacagccgggtgacaacataaccttctcagacaatggaggtctaatagcaccaagtcgagttagcaaattaactggaagggatttgggaatccaatcagaagcgttgatagacaacagttgtgaatccaaatgcttttggagagggggttctataaatacaaagctcccttttcaaaatctgtcacccagaacagtaggtcaatgccccaaatacgtaaatcagaggagtttactgcttgcaacagggatgaggaatgtgccagaagtggtgcagggaaggggtctgtttggtgcaatagcagggttcatagaaaacggatgggaaggaatggtagacggctggtatggtttcagacaccaaaatgcccagggcacaggccaagctgctgattacaagagtactcaagcagctattgaccaaatcacagggaaactgaacaggttgattgagaagaccaacactgagtttgagtcaatagaatctgaattcagtgagactgagcatcaaattggtaacgtcattaattggaccaaagattcaataaccgacatttggacttacaacgcagagctattagtggcaatggagaatcagcacacaattgacatggctgattcagagatgctaaatctgtatgaaagggtaagaaagcaactcagacagaatgcagaagaagacggaaagggatgttttgagatatatcatacttgtgatgattcgtgcatggagagtataaggaacaatacttatgaccattcacaatacagagaggaggctcttctgaatagactgaacatcaacccagtgaaactttcttcggggtacaaagacatcatactttggtttagcttcggggaatcatgctttgttcttctagccgttgttatgggtcttgttttcttctgcctgaaaaatggaaacatgcgatgcacaatctgtatttagttaaaaacaccttgtttctact

SEQ ID NO: 17 - DNA, 1698 bp, Influenza A virus
atggagaaaacactgctatttgcaactattttcctttgtgtaaaggcagatgaaatctgtataggctacctaagcaacaactcaacagacaaagttgatacaataatcgagaacaatgtcacggtaaccagctcagtggaactagtcgaaacggaacacactggatcattctgttcaatcaatgggaaacaaccgataagccttggagattgctcttttgcagggtggatattgggaaatcccatgtgtgatgatttaattggtaagacttcatggtcctatatcgtggagaaacctaacccaacaaacggaatttgttacccaggaatattggagaatgaagaagaactgagactgaaattcagtggagtcttggaattcaataaattcgaggcattcacatcaaatggatggggtgctgtgaattcaggggcaggagtgaccgctgcatgcaaattcggaagctccaattctttcttccgaaacatgatctggctgatacatcaatcaggaacatatcctgtaataaagaggaccttcaacaacaccaaaggaagagatgtgttggttgtttggggaattcaccatcctgctacactgaaagagcatcaagacctatacaaaaaagacagttcctatgtagcagtgggttcagagacctacaacagaagattcaccccagaaatcagcactaggcctaaagttaatggacaggctggacgaatgacattttattggacaatagtcaaaccaggagagtcaataacatttgagtccaatggtgcattcctggctcctagatatgcttttgagattgtctctgttggaaatggaaaactattcaggagtgaactgaatattgaatcatgttctaccaaatgtcaaacagaagtaggaggaattaacacaaacaaaagcttccacagtgttcatagaaacactatcggagactgtcccaaatacgtgaatgtcaagtccctgaaacttgccacgggacttagaaatgtcccagcaatagcatcaagaggcttgtttggagcaatagccggatttatagaaggtggatggcctggactgatcaatggatggtacgggtttcaacacaggaatgaagaaggaacaggcatagcagcagacaaggaatcaactcagaaggcaatagaccagataacgtctaaggtaaataatatcgtcgatagaatgaatacaaatttcgagtctgtacaacacgaattcagtgaaatagaggagaggataaaccgattgtcgaaacatgtagatgattctgtggttgacatctggtcatataatgcacaactcctcgttttgcttgaaaatgaaaagaccctggacctccacgactccaatgtcagaaatctccatgagagagttagaaggatgctaaaggacaatgccaaagacgagggaaatggatgtttcaccttttaccataagtgtgacaacgaatgcatcgaaaaagttagaaacggaacatatgatcacaaagaattcgaaaaggaatcaaaaatcaatcgccaggagattgagggggtgaaattagactccagtgggaatgtgtataaaatactgtcaatttacagctgcattgcaagcagtctcgtactggcagcactcatcatgggtttcatcctctgggcgtgcagtaatggatcatgtagatgtaccatttgcatttag

SEQ ID NO: 18 - DNA, 1695 bp, Influenza A virus
atggaaaaattcatcattttgagtactgtcttggcagcaagctttgcatatgacaaaatttgcattggataccaaacaaacaactcgactgaaacggtaaacacactaagtgaacaaaacgttccggtgacgcaggtggaagaacttgtacatcgtgggattgatccgatcctgtgtggaacggaactaggatcaccactagtgcttgatgactgttcattagagggtctaatcctaggcaatcccaaatgtgatctttatttgaatggcagggaatggtcatacatagtagagaggcccaaagagatggaaggagtttgctatccagggtcaattgaaaaccaggaagagctaagatctctgttttcttccatcaaaaaatatgaaagagtgaagatgtttgatttcaccaaatggaatgtcacatacactgggaccagcaaggcctgcaataatacatcaaaccaaggctcattctataggagcatgagatggttgaccttaaaatcaggacaatttccagtccaaacagatgagtacaagaacaccagagattcagacattgtattcacctgggccattcaccacccaccaacatctgatgaacaagtaaaattatacaaaaatcctgatactctctcttcagtcaccaccgtagaaatcaataggagcttcaagcctaatatagggccaagaccactcgtgagaggacaacaagggagaatggattactactgggctgttcttaaacctggacaaacagtcaaaatacaaaccaatggtaatcttattgcacctgaatatggtcacttaatcacagggaaatcacatggcaggatactcaagaataatttgcccatgggacagtgtgtgactgaatgtcaattgaacgagggtgtaatgaacacaagcaaacctttccagaacactagtaagcactatattgggaaatgccccaaatacataccatcagggagtttaaaattggcaatagggctcaggaatgtcccacaagttcaagatcgggggctctttggagcaattgcaggtttcatagaaggcggatggccagggctagtggctggttggtacggatttcagcatcaaaatgcggaggggacaggcatagctgcagacagagacagcacccaaagggcaatagacaatatgcaaaacaaactcaacaatgtcatcgacaaaatgaataaacaatttgaagtggtgaatcatgagttttcagaagtggaaagcagaataaacatgattaattccaaaattgatgatcagataactgacatatgggcatacaatgctgaattgcttgtcctattggaaaatcagaagacattagatgagcatgacgctaatgtaaggaatctacatgatcgggtcagaagagtcctgagggaaaatgcaattgacacaggagacggctgctttgagattttacataaatgtgacaacaattgtatggacacgattagaaacgggacatacaatcacaaagagtatgaggaagaaagcaaaatcgaacgacagaaagtcaatggtgtgaaacttgaggagaattctacatataaaattctgagcatctacagcagtgttgcctcaagcttagttctactgctcatgattattgggggtttcattttcgggtgtcaaaatggaaatgttcgttgtactttctgtatttaa

SEQ ID NO: 19 - DNA, 1701 bp, Influenza A virus
atggctctaaatgtcattgcaactttgacacttataagtgtatgtgtacatgcagacagaatatgcgtggggtatctgagcaccaattcatcagaaagggtcgacacgctccttgaaaatggggtcccagtcaccagctccattgatctgattgagacaaaccacacaggaacatactgttctctaaatggagtcagtccagtgcatttgggagattgcagctttgaaggatggattgtaggaaacccagcctgcaccagcaactttgggatcagagagtggtcatacctgattgaggaccccgcggcccctcatgggctttgctaccctggagaattaaacaacaatggtgaactcagacacttgttcagtggaatcaggtcattcagtagaacggaattgatcccacctacctcctggggggaagtacttgacggtacaacatctgcttgcagagataacacgggaaccaacagcttctatcgaaatttagtttggtttataaagaagaatactagatatccagttatcagtaagacctacaacaatacaacgggaagggatgttttagttttatggggaatacatcacccagtgtctgtggatgagacaaagactctgtatgtcaatagtgatccatacacactggtttccaccaagtcttggagcgagaaatataaactagaaacgggagtccgacctggctataatggacagaggagctggatgaaaatttattggtctttgatacatccaggggagatgattactttcgagagtaatggtggatttttagccccaagatatgggtacataattgaagaatatggaaaaggaaggattttccagagtcgcatcagaatgtctaggtgcaacaccaagtgccagacttcggttggagggataaacacaaacagaacgttccaaaacatcgataagaatgctcttggtgactgtcccaaatacataaagtctggccaactcaagctagccactggactcagaaatgtgccagctatatcgaatagaggattgttcggagcaattgcagggttcatagaaggaggctggccaggtttaatcaatggttggtacggttttcagcatcaaaatgaacagggaacaggaatagctgcagacaaagaatcaacacagaaagctatagaccagataacaaccaaaataaataacattattgataaaatgaatgggaactatgattcaattaggggtgaattcaatcaagttgagaagcgtataaacatgcttgcagacagaatagatgatgccgtgacggacatttggtcatacaatgccaaacttcttgtattgctggaaaatgataaaactttagatatgcatgatgctaatgtaaagaatttacatgagcaagtacgaagagaattgaaggacaatgcaattgacgaaggaaatggctgttttgaactccttcataaatgcaatgactcctgcatggaaactataagaaatggaacgtatgaccacactgagtatgcagaggagtcaaagttaaagaggcaagaaatcgatgggatcaaactcaaatcagaagacaacgtttacaaagcattatcaatatacagttgcattgcaagtagtgttgtactagtaggactcatactctctttcatcatgtgggcctgtagtagtgggaattgccgattcaatgtttgtatataa

SEQ ID NO: 20 - DNA, 1716 bp, Influenza A virus
ttggttgcactggctctgagccaaactgcttattctcagatcacaaatgggacaacaggaaaccccattatatgcttggggcaccatgcagtggaaaacggcacatctgttaaaacactaacagacaatcacgtggaagttgtgtcagctaaagaattagttgagacgaaacacactgatgaactgtgcccaagccccttgaagcttgtcgacgggcaagactgcgacctcatcaatggtgcattggggagtccaggctgtgatcgtttgcaggacaccacttgggatgtcttcattgaaaggcccactgcagtagacacatgttatccattcgacgtcccagattaccagagtctcagaagcattctagcaagcagtgggagtctggagttcatcgccgaacaattcacctggaatggtgtcaaagttgacggatcaagcagtgcttgtttgaggggcggtcgcaacagcttcttctcccggctaaactggctaaccaaagcaacaaatggaaactatggacctattaacgtcactaaagaaaatacgggctcttatgtcaggctctatctctggggagtgcatcacccatcaagcgataatgagcaaacggatctctacaaggtggcaacagggagagtgacagtatctacccgctcggatcaaatcagtattgttcccaatataggaagtagaccgagagtaaggaatcagagcggcaggataagcatctactggaccctagtaaacccaggggactccatcattttcaacagtattgggaatttgattgcaccaagaggccattacaaaataagtaaatctactaagagcacagtgcttaaaagtgacaaaaggattgggtcatgcacaagcccttgcttaactgataaaggttcgatccaaagtgacaaaccttttcagaatgtatcaaggattgctataggaaactgcccgaagtatgtaaagcaagggtccttgatgttagcaactggaatgcgcaacatccctggcaaacaggcaaagggcttatttggggcaattgctggattcattgaaaatggttggcaaggcctgattgatgggtggtatggattcaggcaccaaaatgctgaaggaacaggaactgctgcagacctgaagtcaactcaggcagccattgatcagataaatggcaagctgaacagattaatagaaaaaacaaatgaaaaatatcaccaaatagaaaaggaattcgaacaggtggaaggaagaatacaagaccttgagaagtacgttgaggacactaagattgatttgtggtcatacaatgctgaattgctagtcgcactagagaatcagcacacaatagatgtcacagactccgaaatgaacaagctttttgaaagagtaagaaggcaattaagagagaatgcagaagatcaaggcaacggttgtttcgagatattccatcagtgtgacaacaattgtatagaaagtattagaaacggaacttatgaccacaacatctacagggatgaagccatcaacaatcgaatcaaaataaatcctgtcactttgacgatggggtacaaggacataatcctgtggatttctttctccatgtcatgctttgtcttcgtggcactgattttgggatttgttctatgggcttgtcaaaacgggaatatccgatgccaaatctgtatataaagaaaaaacacccttgtttctact

SEQ ID NO: 21 - DNA, 1762 bp, Influenza A virus
agcaaaagcaggggatacaaaatgaacactcaaatcattgtcattctagtcctcggactgtcaatggtgaaatctgacaagatttgtctcgggcaccatgccgtagcaaatgggacaaaagtcaacacactaactgagagaggagtggaagtggtcaatgccacggagacagtggagattaccggaatagataaagtgtgcacaaaagggaagaaagcagtggacctgggatcttgtggaatactgggaactatcattgggcctccacaatgtgatcttcatcttgaattcaaagctgatctgataatagaaagaagaaattcaagtgacatctgttacccaggaagattcactaatgaggaagcactgagacaaataatcagagaatctggaggaattgacaaagagtcaatgggctttagatattcaggaataagaacagacggggcaaccagtgcgtgtaagagaacagtgtcctctttctactcagaaatgaaatggctttcatccagcatgaataaccaggtgttcccacaactgaatcagacatacaggaacaccagaaaagaaccagccctaattgtctggggagtacatcattcaagttccttggatgagcaaaataagctatatggaactgggaacaagctgataacagtaggaagctcaaagtaccaacaatcgttttcaccaagtccaggggccaggcccaaagtgaatggtcaggccgggaggatcgactttcattggatgctattggacccaggggatacagtcacttttaccttcaatggtgcattcatagccccagatagagccacctttctccgctctaatgccccttcaggaattgagtacaatgggaagtcactgggaatacagagtgatgcacaaatcgatgaatcatgtgaaggggaatgcttctacagtggagggacaataaacagccctttaccatttcaaaacatcgatagtagggctgtcggaaagtgccccagatatgtgaagcaatcaagcttgccgctggccttaggaatgaaaaatgtaccagagaaaatacgtactaggggactgttcggtgcaattgcaggattcatcgaaaatggatgggaagggctcattgatggatggtatggatttaggcatcagaatgcacaagggcagggaacagctgctgactacaagagtactcaggctgcaattgaccagataacagggaaacttaataggttaattgaaaaaaccaacaaacagtttgaactcatagacaatgagttcactgaagtggagcagcagataggcaatgtaataaactggacaagggactccttgactgagatctggtcatacaatgccgaactgctagtagcaatggagaatcagcatacaattgaccttgcagattctgaaatgaacaaactctatgagagagtgagaagacagctaagggagaatgccgaggaggatggaactggatgttttgagattttccaccgatgtgacgatcaatgtatggagagcatacggaataatacttacaatcacactgaatatcgacaggaagccttacaaaataggataatgatcaatccggtaaagcttagtagtgggtacaaagatgtgatactatggtttagcttcggggcatcatgtgtaatgcttctagccattgctatgggtcttattttcatgtgtgtgaaaaacgggaatctgcggtgcactatctgtatataattatttgaaaaacacccttgtttctact

SEQ ID NO: 22 - DNA, 1760 bp, Influenza A virus
agcaaaagcaggggatattgtcaaaacaacagaatggtgatcaaagtgctctactttctcatcgtattgttaagtaggtattcgaaagcagacaaaatatgcataggatatctaagcaacaacgccacagacacagtagacacactgacagagaacggagttccagtgaccagctcagttgatctcgttgaaacaaaccacacaggaacatactgctcactgaatggaatcagcccaattcatcttggtgactgcagctttgagggatggatcgtaggaaacccttcctgtgccaccaacatcaacatcagagagtggtcgtatctaattgaggaccccaatgcccccaacaaactctgcttcccaggagagttagataataatggagaattacgacatctcttcagcggagtgaactcttttagcagaacagaattaataagtcccaacaaatggggagacattctggatggagtcaccgcttcttgccgcgataatggggcaagcagtttttacagaaatttggtctggatagtgaagaataaaaatggaaaataccctgtcataaagggggattacaataacacaacaggcagagatgttctagtactctggggcattcaccatccggatacagaaacaacagccataaacttgtacgcaagcaaaaacccctacacattagtatcaacaaaggaatggagcaaaagatatgaactagaaattggcaccagaataggtgatggacagagaagttggatgaaactatattggcacctcatgcgccctggagagaggataatgtttgaaagcaacgggggccttatagcgcccagatacggatacatcattgagaagtacggtacaggacgaattttccaaagtggagtgagaatggccaaatgcaacacaaagtgtcaaacatcattaggtgggataaacaccaacaaaactttccaaaacatagagagaaatgctcttggagattgcccaaagtacataaagtctggacagctgaagcttgcaactgggctgagaaatgtcccatccgttggtgaaagaggtttgtttggtgcaattgcaggcttcatagaaggagggtggcctgggctaattaatggatggtatggtttccagcatcagaatgaacaggggactggcattgctgcagacaaagcctccactcagaaagcgatagatgaaataacaacaaaaattaacaatataatagagaagatgaacggaaactatgattcaataagaggggaattcaatcaagtagaaaagaggatcaacatgctcgctgatcgagttgatgatgcagtaactgacatatggtcgtacaatgctaaacttcttgtactgcttgaaaatgggagaacattggacttacacgacgcaaatgtcaggaacttacacgatcaggtcaagagaatattgaaaagtaatgctattgatgaaggagatggttgcttcaatcttcttcacaaatgtaatgactcatgcatggaaactattagaaatgggacctacaatcatgaagattacagggaagaatcacaactgaaaaggcaggaaattgagggaataaaattgaagtctgaagacaatgtgtataaagtactgtcgatttatagctgcattgcaagcagtattgtgctggtaggtctcatacttgcgttcataatgtgggcatgcagcaatggaaattgccggtttaatgtttgtatatagtcggaaaaaatacccttgtttctact

SEQ ID NO: 23 - DNA, 1417 bp, Influenza A virus
agcaaaagcaggagttcaaaatgaatccaaatcagaagataataaccatcggatcaatctgtatggtaactggaatagttagcttaatgttacaaattgggaacatgatctcaatatgggtcagtcattcaattcacacagggaatcaacaccaatctgaaccaatcagcaatactaaatttcttactgagaaagctgtggcttcagtaaaattagcgggcaattcatctctttgccccattaacggatgggctgtatacagtaaggacaacagtataaggatcggttccaagggggatgtgtttgttataagagagccgttcatctcatgctcccacttggaatgcagaactttctttttgactcagggagccttgctgaatgacaagcactccaatgggactgtcaaagacagaagccctcacagaacattaatgagttgtcctgtgggtgaggctccctccccatataactcaaggtttgagtctgtcgcttggtcagcgagtgcttgccatgatggcaccagttggttgacaattggtatttctggcccagacaatggggctgtggctgtagtgaagtacaatggcataataacagacactatcaagagttggaggaacaacatactgagaactcaagagtctgagtgtgcatgtgtaaatggctcttgctttactgtaatgactgacggaccaagtaatggtcaggcatcacataagatcttcaaaatggaaaaagggaaagtggttaaatcagtcgaattggatgctcctaattatcactatgaggaatgctcctgttatcctgatgccggcgaaatcacatgtgtgtgcagggataattggcatggctcaaatcggccatgggtgtctttcaatcaaaatttggagtatcaaataggatatatatgcagtggagttttcggagacaatccacgccccaatgatggaacaggtagttgtggtccggtgtcctctaatggggcatatggggtaaaaggtttttcatttaaatacggcaatggtgtctggatcgggagaaccaaaagcactaattccaggagcggctttgaaatgatttgggatccaaatgggtggactgaaacggacagtagcttttcagtgaaacaagatatcgtagcaataactgattggtcaggatatagcgggagttttgtccagcatccagaactgacaggactagattgcataagaccttgtttctgggttgagttgatcagagggcggcccaaagagagcacaatttggactagtgggagcagcatatctttttgtggtgtaaatagtgacactgtgggttggtcttggccagacggtgctgagttgccattcaccattgacaagtagtttgttcaaaaaaactccttgtttctactaataagagacgtgtgtga

SEQ ID NO: 24 - DNA, 1398 bp, Influenza A virus
atgaatccaaatcagaaaataatagcaattggctctgtttctctaactattgcgataatatgttttctcatgcagattgccatcttaacaacgactatgacactacatttcaagcagaatgaatgcagcaacccatcgaataatcaagtagtgccatgtgaaccaatcatgatagagaggaacatagtgcatttgaacagtactatcatagagaaggaaatttgtcccaaagtggcagaatacaagaattggtcaaaaccacaatgtcaaattacagggttcgctcctttctcaaaggacaactcaattaggctttccgcaggtggggatatctgggtgacaagagaaccttatgtgtcgtgcggtcttggtaaatgttatcaatttgcacttgggcaggggaccactttgaaaaacaaacactcaaatggcactacacatgatagaattcctcatagaacccttttaatgaatgagttaggtgtcccgtttcatttgggaaccaaacaagtgtgcatagcatggtccagctcaagctgccatgatgggaaagcatggttacatatttgtgtcactggggatgataaaaatgcgactgctagtatcatttatgatgggatgcttgttgacagtattggttcatggtccaaaaacatcctcagaactcaggagtcagaatgcgtttgcatcaatggaacttgtacagtagtaatgactgatggaagtgcatcaggaaaggctgacactagaatactattcataagagaagggaaaattgtacatattagcccattgtcaggaagtgctcagcatgtggaggaatgctcctgttacccccggtatccagaagttaggtgtgtttgcagagacaattggaagggctccaataggcctgatctatatataaatattgcagattatagtattgagtccagttatgtgtgctcaggacttgttggcgacacaccaagagacgatgatagctccagcagcagcaactgcaggtatcctaataacgagagaggggccccaggagtgaaagggtgggcctttgacgttggaaatgatatttggatgggacggacaatcaaagaggattcacgctcaggttatgagactttcagggtcattggtggttggaccacggctaattccaagtcacagataaatagacaagtcatagttggcagtgacaactggtctgggtattctggtatcttctctgttgaaggcaaaaactgcatcaacagatgtttttatgtggagttgataagaggaagaccacaggagactagggtgtggtggacttcaaatagcatcattgtattttgtggaacctcaggtacctatggaacaggctcatggcctgatggggcgaatatcaacttcatggcttag

SEQ ID NO: 25 - DNA, 1453 bp, Influenza A virus
agcaaaagcaggtgcgagatgaatccgaatcagaagataataacaatcggggtagtgaataccactctgtcaacaatagcccttctcattggagtgggaaacttagttttcaacacagtcatacatgagaaaataggagaccatcaaatagtgacccatccaacaataatgacccctgaagtaccgaactgcagtgacactataataacatacaataacactgttataaacaacataacaacaacaataataactgaagcagaaaggcctttcaagtctccactaccgctgtgccccttcagaggattcttcccttttcacaaggacaatgcaatacgactgggtgaaaacaaagacgtcatagtcacaagggagccttatgttagctgcgataatgacaactgctggtcctttgctctcgcacaaggagcattgctagggactaaacatagcaatgggaccattaaagacagaacaccatataggtctctaattcgtttcccaataggaacagctccagtactaggaaattacaaagagatatgcattgcttggtcgagcagcagttgctttgacgggaaagagtggatgcatgtgtgcatgacagggaatgataatgatgcaagtgcccagataatatatggaggaagaatgacagactccattaaatcatggaggaaagacatactaagaacccaggagtctgaatgtcaatgcattgacgggacttgtgttgttgctgtcacagatggccctgctgctaatagtgcagatcacagggtttactggatacgggagggaagaataataaagtatgaaaatgttcccaaaacaaagatacaacacttagaagaatgttcctgctatgtggacattgatgtttactgtatatgtagggacaattggaagggctctaacagaccttggatgagaatcaacaacgagactatactggaaacaggatatgtatgtagtaaatttcactcagacacccccaggccagctgacccttcaataatgtcatgtgactccccaagcaatgtcaatggaggacccggagtgaaggggtttggtttcaaagctggcaatgatgtatggttaggtagaacagtgtcaactagtggtagatcgggctttgaaattatcaaagttacagaagggtggatcaactctcctaaccatgtcaaatcaattacacaaacactagtgtccaacaatgactggtcaggctattcaggtagcttcattgtcaaagccaaggactgttttcagccctgtttttatgttgagcttatacgagggaggcccaacaagaatgatgacgtctcttggacaagtaatagtatagttactttctgtggactagacaatgaacctggatcgggaaattggccagatggttctaacattgggtttatgcccaagtaatagaaaaaagcaccttgtttctact

SEQ ID NO: 26 - DNA, 1413 bp, Influenza A virus
atgaatccaaatcaaaagattataaccattggtagtgtgagcattgtactgacaacagtaggattgctactccaaataacaagcttgtgttcaatatggttcagtcattacaaccaggtaacccaaacaaacggacaaccatgttcgaacgacacgataaattactacaatgagacttttgtcaatgtcacaaacgtgcagaacaattataccaccatcactgaaccttcaatcccccaggcaattcactattccagtgggagagacctatgcccggtgaaaggatgggcacctttgagcaaggacaatgggatcagaattggatccaggggcgaggtatttgtcatacgagagcccttcatatcatgttccattaatgaatgcagaacttttttcctgacccaaggtgctctcctcaatgacaaacactcgaatgggacagtaaaagataggagtccttttcgcacactaatgagttgccctataggggttgccccttcccctagtaacagtcgttttgagtctgtagcttggtctgccactgcatgcagcgatggacccggctggttgacattaggaattacaggtcctgatactactgctgttgcagtattgaagtacaatggtgttatcacagacacactaaagagctggaaaggcaacattatgcgaacacaagagtctgaatgcgtgtgtcaggatgagttttgttacactctagttacagacggaccgtccgatgcacaggctttctacaagatattaaagatcaaaaaagggaaaatagtaggtgcaaaagatgtagatgcaacaggattccatttcgaggagtgttcctgttacccaagtggggaaaatgtcgagtgtgtgtgcagagacaactggagagggagtaatagaccatggataagattcaacagtgaccttgactatcaaattggctatgtatgtagtggggtgttcggagacaaccccaggcctgtggatggtacagggtcgtgcaacagcccagtcaacaatgggaagggaagatacggagtgaaagggttcagttttagatatggagatggagtttggatagggaggacaaaaagcttggagtccagaagtgggtttgagatggtttgggacgcaaacgggtgggtttcaacagacaaggactcaaatggtgtacaggatattatagacaatgacaattggtctggctatagtggaagtttcagcattaggggagaaacaactggcaggaactgcactgtaccgtgtttttgggttgaaatgataaggggacagcctaaggagaaaaccatatggactagcggtagtagtattgcattctgtggtgttaattctgataccacaagttggtcatggcctgatggcgctctgttgccatttgacatagacaagtaa

SEQ ID NO: 27 - DNA, 1432 bp, Influenza A virus
taaaatgaatccaaatcagaaaataataacaattggttctgtgtcattggcactagttgtattcaacatactgcttcatattgcatcaatagtcataggaataatatcagtgacaaaagaaagcagtgtaccatcaccatgcaacaccactgagatttacaatgaaactgtaaggctggaaactataacaattcctatcaataacactgtgtacatagaaagagagtcacatcaagaacctgagttcttaaacaatacagaacctctctgcaatgtatcagggtttgcaatagtttccaaggacaatggaatcagaattgggtcaaggggacatgtgtttgtcataagagaaccatttgtggcatgtggtcccacagaatgtaggacatttttcctaacgcaaggtgccttactgaatgataaacattccaacaatacagtgaaagatagaagtccttatcgtgcactaatgagtgtgccattaggatcttcacccaatgcttaccaggccaagtttgagtctgttgcatggtcggccacagcatgccatgatggcaaaaaatggctggcagtaggggtaagtggtgcagatgacgatgcttatgcagtaatccattatggggggatgccaacagatgtggtgaggtcatggagaaagcaaattctaagaacacaagaatcgtcatgtgtatgtatgaaaggagactgttattgggtaatgacggatggtcctgcgaacaatcaggctagttacaggattttcaagtctcataagggaatggtgacaaatgaaagagaagtgtcttttcagggaggtcacattgaagagtgctcttgctaccccaatttgggtaaagtggagtgcgtttgccgagataattggaatgggatgaatagaccaatattgatttttgatgaggacctgaactatgatgtgggttatttatgtgctggaataccgacagacaccccacgggttcaggacagtagtttcactggttcttgcactaatgctgttggagggagtgggacgaacaactatggagtgaagggatttggcttcagacaaggcaatagtgtgtgggcaggaagaacagttagcatttcgtcccgaagtggttttgagatcctattgatagaggaaggttggaccaaaacaagcaaaaatgtcgtcaaaaaagtggaggtcctcaacaataagaattggtcaggatacagtggagcattcaccataccgatcacaatgactagtaaacaatgcttagttccatgtttctggctggaaatgataagaggaaaaccagaagagaggacaagcatttggacctctagtagctccacggtattttgtggtgtctcaagtgaggtcccagggtggtcctgggatgatggagcaattcttccctttgacatcgataagatgtaatttgta

SEQ ID NO: 28 - DNA, 1413 bp, Influenza A virus
atgaatccaaatcaaaagataatatgcatctcagcaacaggaatgatactatccgtagtaagtctgctaataggattggccaacttgggtctgaacatagggcttcatttcaaggtaagagacacaccggaaacagagacccccagcatcaatacaacaaactccacaaacacgataattaactacaacactcaaaacaatttcacaaatgtgaccaatattgtgttaattaaggaagaaagcaaaatgttcacaaacctttcgaaacctttgtgtgaagtaaactcatggcacattctatctaaggacaatgcgatcagaataggagaggatgctcacatccttgtcacaagagaaccatatctctcatgtggaccacatgaatgcaggatgtttgccctcagccaaggcactacactaaggggtcgacatgcaaatgggactatacatgacagaagcccatttagggcattaataagttgggaaatggggcaagcaccgagtccatacaatatcagagtagaatgtataggatggtccagcacttcatgccatgacggcatctcaagaatgtcaatctgcatgtcaggacctaataacaatgcttcggcagtggtctggtacaatggaaggccagtcaccgaaattgcttcgtgggcaggaaatatattaagaactcaggaatcagaatgtgtgtgccataatggaatatgccctgtggtgatgacggatggcccagctaacaacagagcagaaacaaaaataatttatttcaaagaggggaaaatacagaagatagaggaactgacaggaaatgcacagcatatagaagagtgctcatgctatggagcagaagaaatgattaaatgcatttgcagggacaattggaagggtgcaaatagaccaataatcactataaacccaaagacaatgactcatacaagcaaatacttgtgttcaaagattctaactgacacaagtagacccaatgaccccggaagcggaaactgtgatgcaccaataaccggagggagcccagatcctggcgtaaaaggatttgcattcttagatgggggaaattcctggttgggaaggaccataagcaaagattcaaggtcagggtatgaaatgctaaaagtcccgaatgcagaaacagataatcagtccggtccagttgcacatcaagtgatagtaaacaaccaaaactggtcagggtactcaggagcgttcatcgattattgggctgatagagagtgctttaacccttgcttttatgtggagttgatcagaggcagaccaaaagagagtagtgtattgtggacatccaatagtatagtagcgctttgtggatccaaggagcgattaggatcttggtcatggcatgatggggctgaaatcatctactttaagtag

SEQ ID NO: 29 - DNA, 1416 bp, Influenza A virus
atgaatccaaatcagaaactatttgcattatctggagtggcaatagcacttagtgtactgaacttattgataggaatctcaaatgtcggattgaatgtatctctacatctaaaggagaaaggacccagacaggaagagaatttaacatgcacgaccattaatcaaagcaacactactgtagtagaaaccacatacgtaaataatacaacaataattaccaaggaaactgatttgaaaacaccaagctacctgctgttgaacaagagcctatgcaacgttggagggtgggtcgtgatagcgaaagacaatgcagtaagatttggggaaagtgaacaaatcattgttaccagggaaccatatgtatcatgcgacccaacagaatgcaaaatgtatgccttgcaccaagggactaccattaggaacaaacattcaaatggaacgattcatgacagaacagctttcagaggtctcatctccactccattgggcactccaccaaccgtaagtaacagtgactttgtatgtgttgggtggtcaagcacaacttgccatgatgggattggcagaatgactatctgcatacaaggaaacaatgacaacgctacagcaacggtttattataacagaaggctgaccactaccattaagacctgggccagaaacattctgaggactcaagaatcagaatgtgtgtgccacaatggcacatgtgcagttgtaatgactgacggatcggctagtagtcaagcctatacaaaagtaatgtatttccacaagggattaataattaaggaggaggcattaaagggatcagccagacatattgaggaatgctcctgttacggacacagtcaaaaggtgacctgtgtgtgcagagacaactggcagggggcaaacaggcctattatagaaattgatatgaacacattggagcacacaagtagatacgtgtgcactggaattctcacagacaccagcagacctggggacaaatctagtggtgattgttccaatccaataactggaagtcctggcgctccgggagtgaagggattcgggtttctaaatggggataacacatggcttggtaggaccatcagccccagatcaagaagtggattcgaaatgttgaaaatacctaatgcaggtactgatcccaattctagaatagcagaacgacaggaaattgtcgacaataacaattggtcaggctattccggaagctttattgactactggaatgataacagtgagtgctacaatccgtgcttttacgtagagttaattagaggaagacctgaagaggctaaatatgtatggtggacaagtaacagtctgattgccctatgtggaagcccattcccagttgggtccggttccttccccgatggggcacagatccaatacttttcgtaa

SEQ ID NO: 30 - DNA, 1413 bp, Influenza A virus
atgaatccaaatcaaaagataatagcaattggatttgcatcattggggatattaatcattaatgtcattctccatgtagtcagcattatagtaacagtactggtcctcaataacaatagaacagatctgaactgcaaagggacgatcataagaaagtacaatgaaacagtaagagtagaaaaaattactcaatggtataataccagtacaattaagtacatagagagaccttcaaatgaatactacatgaacaacactgaaccactttgtgaggcccaaggctttgcaccattttccaaagataatggaatacgaattgggtcgagaggccatgtttttgtgataagagaaccttttgtatcatgttcgccctcagaatgtagaacctttttcctcacacagggctcattactcaatgacaaacattctaacggcacagtaaaggaccgaagtccgtataggactttgatgagtgtcaaaatagggcaatcacctaatgtatatcaagctagatttgaatcggtagcatggtcagcaacagcatgccatgatggaaaaaaatggatgacagttggagtcacagggcccgacaatcaagcaattgcagtagtgaactatggaggtgttccggttgatattattaattcatgggcaggggatattttaagaacccaagaatcatcatgcacctgcattaaaggagactgttattgggtaatgactgatggaccggcaaataggcaagctaaatataggatattcaaagcaaaagatggaagagtaattggacagactgatataagtttcaatgggggacacatagaggagtgttcttgttaccccaatgaagggaaggtggaatgcatatgcagggacaattggactggaacaaatagaccagttctggtaatatcttctgatctatcgtacacagttggatatttgtgtgctggcattcccactgacactcctaggggagaggatagtcaattcacaggctcatgtacaagtcctttgggaaataaaggatacggtgtaaaaggtttcgggtttcgacaaggaactgacgtatgggccggaaggacaattagtaggacttcaagatcaggattcgaaataataaaaatcaggaatggttggacacagaacagtaaagaccaaatcaggaggcaagtgattatcgatgacccaaattggtcaggatatagcggttctttcacattgccggttgaactaacaaaaaagggatgtttggtcccctgtttctgggttgaaatgattagaggtaaacctgaagaaacaacaatatggacctctagtagctccattgtgatgtgtggagtagatcataaaattgccagttggtcatggcacgatggagctattcttccctttgacatcgataagatgtaa

SEQ ID NO: 31 - DNA, 1456 bp, Influenza A virus
gagcaaaagcagggtcaagatgaatccaaatcagaagattctatgcacttctgccactgctattgtaataggcacaattgcagtactaataggaatagcgaacttaggattgaatataggactacatctgaaaccagactgcaactgctcacactcacaacctgaagcaaccaatgcaagccaaacaataataaacaactactataacgaaacaaacatcacccaaataagtaataccaacatccaaatggaggaaaaggcaagtagagaattcaataacttgaccaaaggactttgcaccataaattcatggcacatatatggaaaagacaatgcagtaagaattggggaggactcagatgttctagtaacgagagaaccctatgtctcctgtgatccagatgagtgcaggttctatgctctcagccaaggaacaacgattagagggagacactcaaatggaacaatacacgacaggtcccagtaccgcgccctgataagctggccactgtcatcaccacccacagtatacaacagcagggtagaatgcattggttggtcaagtactagttgccatgatggtagagccaggatgtcaatatgtatatcaggcccgaacaacaatgcatcagcagtaatctggtataatagaaggcctgttacagagatcaatacatgggcccgaaacatactacggacacaagagtctgaatgtgtatgccacaacggtgtctgcccagtagtgttcacagatgggtccgccactgggcctgcagaaacaagagtatactatttcaaagaagggaaaatactaaaatgggaacctctgactggaactgctaagcacattgaagaatgctcatgctacggggaacaagcaggtattacttgcacttgcagggataattggcagggctcaaatagaccagtaattcaaatagatccagtagcgatgacacatactagtcagtatatatgtagccctgttcttacagataatccccgaccgaacgacccaactgtaggtaagtgtaatgacccttatccgggaaataacaacaatggagtcaagggattttcgtacctggatggaggtaacacttggctaggaaggacaataagcacagcttcaagatcggggtacgagatgctaaaggtgccaaatgcattgaccgacgataggtcaaaacccactcaaggccaaacaatcgtattaaacactgactggagtggctacagtgggtccttcatggactattgggccgagggggagtgctaccgagcgtgtttttatgtagagttaatacgcggaagacccaaggaggacaaagtatggtggaccagtaatagtatagtatcgatgtgttccagcacagaattccttggacaatggaactggcctgatggggctaaaatagagtacttcctctaagacacagaaaaaagacccttgttt

SEQ ID NO: 32 - DNA, 1050 bp, Influenza B virus
gagcatttgtttagtcactggcaaacaggaaaaatggcggacaacatgaccacaacacaaattgaggtgggtccgggagcaaccaatgccaccataaactttgaagcaggaattttggagtgctatgaaaggctttcatggcaaagagcccttgactaccctggtcaagaccgcctaaacagactaaagagaaaattagagtcaagaataaagactcacaacaaaagtgagcctgaaagtaaaaggatgtctcttgaagagagaaaagcaattggagtaaaaatgatgaaagtgctcctatttatggatccatctgctggaattgaagggtttgagccatactgtatgaaaagttcctcaaatagcaactgtccgaaatacaattggaccgattacccttcaacaccaggaaggtgccttgatgacatagaagaagaaccagaggatgttgatggcccaactgaaatagtattaagggacatgaacaacaaagatgcaaggcaaaagataaaggaggaagtaaacactcagaaagaagggaagttccgtttgacaataaaaagggatatacgtaatgtgttgtccttgagagtgttggtaaacggaacattcctcaaacaccccaatggatacaagtccttatcaactctgcatagattgaatgcatatgaccagagtggaaggcttgttgctaaacttgttgctactgatgatcttacagtggaggatgaagaagatggccatcggatcctcaactcactcttcgagcgtcttaatgaaggacattcaaagccaattcgagcagctgaaactgcggtgggagtcttatcccaatttggtcaagagcaccgattatcaccagaagagggagacaattagactggtcacggaagaactttatcttttaagtaaaagaattgatgataacatattgttccacaaaacagtaatagctaacagctccataatagctgacatggttgtatcattatcattattagaaacattgtatgaaatgaaggatgtggttgaagtgtacagcaggcagtg

SEQ ID NO: 33 - DNA, 1171 bp, Influenza B virus
aggcactttcttaaaatgtcgctgtttggagacacaattgcctacctgctttcattgacagaagatggagaaggcaaagcagaactagcagaaaaattacactgttggttcggtgggaaagaatttgacctagactctgccttggaatggataaaaaacaaaagatgcttaactgatatacaaaaagcactaattggtgcctctatctgctttttaaaacccaaagaccaggaaaggaaaagaagattcatcacagagcctctatcaggaatgggaacaacagcaacaaaaaagaaaggcctgattctagctgagagaaaaatgagaagatgtgtgagctttcatgaagcatttgaaatagcagaaggccatgaaagctcagcgctactatattgtctcatggtcatgtacctgaatcctggaaattattcaatgcaagtaaaactaggaacgctctgtgctttgtgcgagaaacaagcatcacattcacacagggctcatagcagagcagcgagatcttcagtgcccggagtgagacgagaaatgcagatggtctcagctatgaacacagcaaaaacaatgaatggaatgggaaaaggagaagacgtccaaaagctggcagaagagctgcaaagcaacattggagtattgagatctcttggagcaagtcaaaagagtggggaaggaattgcaaaggatgtaatggaagtgctaaagcagagctctatgggaaattcagctcttgtgaagaaatatctataatgctcgaaccatttcagattctttcaatttgttcttttatcttatcagctctccatttcatggcttggacaatagggcatttgaatcaaataaaaagaggagtaaacatgaaaatacgaataaaaggtccaaacaaagagacaataaacagagaggtatcaattttgagacacagttaccaaaaagaaatccaggccaaagaaacaatgaaggaagtactctctgacaacatggaggtattgagtgaccacatagtgattgaggggctttctgccgaagagataataaaaatgggtgaaacagttttggagatagaagaattgcattaaattcaatttttactgtatttcttattatgcatttaagcaaattgtaatcaatgtcagcaaataaactggaaaaagtgcgt

SEQ ID NO: 34 - DNA, 1479 bp, Influenza B virus
atgaacaatgctaccttcaactatacaaacgttaaccctatttctcacatcagggggagtgttattatcactatatgtgtcagcttcactgtcatacttactatattcggatatattgctaaaattttcaccaacagaaataactgcaccaacaatgccattgaattgtgcaaacgcatcaaatgttcaggctgtgaaccgttctgcaacaaaaggggtgacacttcctctcccagaaccggagtggacataccctcgtttatcttgcccgggctcaacctttcagaaagcactcctaattagccctcatagattcggagaaaccaaaggaaactcagctcccttgataataagggaaccttttattgcttgtggaccaaaggaatgcaaacactttgctctaacccattatgcagcccaaccagggggatactacaatggaacaagagaagacagaaacaagctgaggcatctaatttcagtcaaattgggcaaaatcccaacagtagaaaactccattttccacatggcagcttggagcgggtccgcatgccatgatggtagagaatggacatatatcggagttgatggccctgacagtaatgcattgctcaaaataaaatatggagaagcatatactgacacataccattcctatgcaaacaacatcctaagaacacaagaaagtgcctgcaattgcatcgggggagattgttatcttatgataactgatggctcagcttcagggattagtgaatgcagatttcttaagattcgagagggccgaataataaaagaaatatttccaacaggaagagtagaacatactgaagaatgcacatgcggatttgccagcaataaaaccatagaatgtgcctgtagagataacagttacacagcaaaaagaccctttgtcaaattaaatgtggagactgatacagcagaaataagattgatgtgcacagagacttacttagacacccccagaccagatgatggaagcataacagggccttgtgaatctaatggggataaagggagtggaggcatcaagggaggatttgttcatcaaagaatggcatccaagattggaaggtggtactctcgaacgatgtctaaaactaaaaggatggggatgggactgtatgtcaagtatgatggagacccatggattgacagtgatgcccttactcttagcggagtaatggtttcaatggaagaacctggttggtattcctttggcttcgaaataaaagataagaaatgtgatgtcccctgtattgggatagagatggtacatgatggtggaaagaagacttggcactcagcagcaacagccatttactgtttaatgggctcaggacaactgctatgggacactgccacaggcgttgatatggctctgtaatggaggaatggttgagtctgttctaaaccctttgttcctattttgtttgaacaattgtccttactgaactt

SEQ ID NO: 35 - DNA, 1732 bp, Influenza B virus
atgtccaacatggatattgacggtatcaacactgggacaattgacaaaacaccggaagaaataacttctggaaccagtgggacaaccagaccaatcatcagaccagcaacccttgccccaccaagcaacaaacgaacccggaacccatccccggaaagagcaaccacaagcagtgaagctgatgtcggaaggaaaacccaaaagaaacagaccccgacagagataaagaagagcgtctacaatatggtagtgaaactgggcgaattctataaccagatgatggtcaaagctggactcaacgatgacatggagagaaacctaatccaaaatgcgcatgctgtggaaagaattctattggctgccactgatgacaagaaaactgaatttcagaagaaaaagaatgccagagatgtcaaagaagggaaagaagaaatagatcacaacaaaacaggaggcaccttttacaagatggtaagagatgataaaaccatctacttcagccctataagaattacctttttaaaagaagaggtgaaaacaatgtacaaaaccaccatggggagtgatggcttcagtggactaaatcacataatgattgggcattcacagatgaatgatgtctgtttccaaagatcaaaggcactaaaaagagttggacttgacccttcattaatcagtacctttgcaggaagcacaatccccagaagatcaggtgcaactggtgttgcgatcaaaggaggtggaactttagtggctgaagccattcgatttataggaagagcaatggcagacagagggctattgagagacatcaaagccaaaactgcctatgaaaagattcttctgaatctaaaaaacaaatgctctgcgccccaacaaaaggctctagttgatcaagtgatcggaagtagaaacccagggattgcagacattgaagatctaaccctgcttgctcgtagcatggtcgttgttaggccctctgtggcgagcaaagtagttcttcccataagcatttacgccaaaatacctcaactagggttcaatgttgaagagtactctatggttgggtacgaagccatggctctttacaatatggcaacacctgtttccatattaagaatgggagatgatgcaaaagataaatcgcaattattcttcatgtcttgcttcggagctgcctatgaagacctgagagttctgtctgcattaacaggcacagaattcaagcctagatcagcattaaaatgcaagggtttccatgttccagcaaaggaacaggtggaaggaatgggggcagctctgatgtccatcaagctccagttttgggctccaatgaccagatctggggggaacgaagtaggtggagacggagggtctggccaaataagttgcagcccagtgtttgcagtggagagacctattgctctaagcaagcaagctgtaagaagaatgctgtcaatgaatattgagggacgtgatgcagatgtcaaaggaaatctactcaagatgatgaatgactcaatggctaagaaaaccaatggaaatgctttcattgggaggaaaatgtttcaaatatcagacaaaaacaaaaccaatcccgttgaaattccaattaagcagaccatccccaatttcttctttgggagggacacagcagaggattatgatgacctcgattattaaagcaacaaaatagacactatggctgtgattgtttcaatacgtttggatg

SEQ ID NO: 36 - DNA, 1837 bp, Influenza B virus
aatgaaggcaataattgtactactcatggtagtaacatccaatgcagatcgaatctgcactgggataacatcgtcaaactcacctcatgtggtcaaaacagctactcaaggggaggtcaatgtgactggtgtgataccactgacaacaacaccaacaaaatctcattttgcaaatctcaaaggaacaaagaccagagggaaactatgcccaacctgtctcaactgcacagatctggatgtggccttaggcagaccaatgtgtgtgggggtcacaccttcggcaaaagcttcaatactccacgaagtcagacctgttacatccggatgctttcctataatgcacgacagaacaaaaatcagacagctacccaatcttctcagaggatatgaaaaaatcagattatcaacccaaaacgttatcaacgcagaaaaggcaccaggaggaccctacagacttggaacctcaggatcttgccctaacgctaccagtagaagcggatttttcgcaacaatggcttgggctgtcccaagggacaacaacaaaacagcaacgaatccactaacagtagaagtaccacacatctgtacaaaagaagaagaccaaattactgtttgggggttccattctgatgacaaaacccaaatgaaaaacctctatggagactcaaatcctcaaaagttcacctcatctgctaatggagtaaccacacattatgtttctcagattggcggcttcccggatcaaacagaagacggagggctaccacaaagcggcagaattgttgttgattacatggtgcaaaaacctgggaaaacaggaacaattgtctatcaaagaggtattttgttgcctcaaaaggtgtggtgcgcgagtggcaggagcaaagtaataaaagggtccttgcctttaattggtgaagcagattgccttcacgaaaaatacggtggattaaacaaaagcaagccttactacacaggagaacatgcaaaagccataggaaattgcccaatatgggtgaaaacacctttgaagcttgccaatggaaccaaatatagacctcctgcaaaactattaaaggaaaggggtttcttcggagctattgctggtttcttagaaggaggatgggaaggaatgattgcaggttggcacggatacacatctcacggagcacatggagtggcagtagcagcagaccttaagagtacgcaagaagccataaacaagataacaaaaaatctcaattctttgagtgagctagaagtaaagaatcttcaaagactaagtggtgccatggatgaactccacaacgaaatactcgagttggatgagaaagtggatgatctcagagctgacacaataagctcacaaatagaacttgcagtcttgctttccaacgaaggaataataaacagtgaagatgagcatctattggcacttgagagaaaactaaagaaaatgctgggtccctctgctgtagacatagggaatggatgcttcgaaaccaaacacaagtgcaaccagacctgcttagacaggatagctgctggcacctttaatgcaggagaattttctcttcccacttttgattcactgaatattactgctgcatctttaaatgatgatggattggataaccatactatactgctctactactcaactgctgcttctagtttggctgtaacattgatgatagctatttttattgtttatatgatctccagagacaatgtttcttgctccatctgtctataaggaaaattaagccctgtattttcctttattgtagtgcttgtttgcttgttatcattacaaagaaacgttattgaaaaatgc

SEQ ID NO: 37 - DNA, 2255 bp, Influenza B virus
gtgcgtttgatttgccataatggatacttttattacaagaaacttccagactacaataatacaaaaggccaaaaacacaatggcagaatttagtgaagatcctgaattacaaccagcaatgctattcaacatctgcgtccatctagaggtttgctatgtaataagtgacatgaattttcttgacgaagaaggaaaagcatatacagcattagaaggacaagggaaagaacaaaacttgagaccacaatatgaagtaattgagggaatgccaagaaccatagcatggatggtccaaagatccttagctcaagagcatggaatagagactccaaagtatctggctgatttgtttgattataaaaccaagagatttatagaagttggaataacaaaaggattggctgatgattacttttggaaaaagaaagaaaagctgggaaatagcatggaactgatgatattcagctacaatcaagactattcgttaagtaatgaatcctcattggatgaggaagggaaagggagagtgctaagcagactcacagagcttcaggctgaattaagtctgaaaaacctatggcaagttctcataggagaagaagatgttgaaaagggaattgactttaaacttggacaaacaatatctagactaagggatatatctgttccagctggtttctccaattttgaaggaatgaggagctacatagacaatatagactctaaaggagcaatagagagaaatttagcaaggatgtctcccttagtatcagtcacacctaaaaagttgaaatgggaggacctaagaccaatagggcctcacatttacaaccatgagctaccagaagttccatataatgcctttcttctaatgtctgatgaactggggctggccaatatgactgaaggaaagtccaaaaaaccgaagacattagccaaagaatgtctagaaaagtactcaacacttcgggatcaaactgacccaatattaataatgaaaagcgaaaaagctaacgaaaatttcctatggaagctttggagagactgtgtaaatacaataagtaatgaggaaatgagtaacgagttacagaaaaccaattatgccaagtgggccacaggggatggattaacataccagaaaataatgaaagaagtagcaatagatgacgaaacaatgtgccaagaagagcctaaaatccctaacaaatgtagagtggctgcttgggttcaaacagagatgaatctattgagcaatctgacaagtaaaagagctctggacctaccagaaatagggccagacgtagcacccgtggagcatgtagggagtgaaagaaggaaatactttgttaatgaaatcaactactgtaaggcctctacagttatgatgaagtatgtgcttttccacacttcattgttgaatgaaagcaatgccagcatgggaaaatacaaagtaataccaataaccaatagagtagtaaatgaaaaaggagaaagtttcgacatgctttatggtctggcggttaaaggacaatctcatctgaggggagatactgatgttgtaacagttgtaactttcgaatttagtagtacagaccccagagtggactcaggaaagtggccaaaatatactgtgtttaggattggctccctatttgtgagtgggagggaaaaatctgtgtacctatattgccgagtgaatggcacaaataagatccaaatgaaatggggaatggaactagaagatgtctgcttcaatcaatgcaacaaatggaagcaattgttgaacaagaatcatcaatacaaggatatgacatgaccaaagcctgtttcaagggagacagagtaaatagccccaaaactttcagtattggaactcaagaaggaaaactagtaaaaggatcctttggaaaagcactaagagtaatatttactaaatgtttgatgcactatgtatttggaaatgcccaattggaggggtttagtgccgagtctaggagacttctactgttgattcaagcattaaaggacagaaagggcccttgggtgttcgacttagagggaatgtattctggaatagaagaatgtattagtaacaacccttgggtgatacagagtgcatactggttcaatgaatggttgggctttgaaaaggaggggagtaaagtattagaatcagtagatgaaataatggatgaataaaaggacatagtactcaatttagtactattttgttcattatgtatctaaaacgtcca

SEQ ID NO: 38 - DNA, 2360 bp, Influenza B virus
cggagcgttttcaagatgacattggctaaaattgaattgttaaaacaactgttaagggacaatgaagccaaaacagtattgaaacaaacaacggtagaccaatataacataataagaaaattcaatacatcaagaattgaaaagaacccttcattaaggatgaagtgggcaatgtgttctaattttcccttggctttgaccaagggtgacatggcaaacagaatccccttggaatacaagggaatacaacttaaaacaaatgctgaagacataggaaccaaaggccaaatgtgctcaatagcagcagttacctggtggaatacatatggaccaataggagatactgaaggtttcgaaaaagtctacgaaagcttttttctcagaaagatgagacttgacaatgccacttggggccgaataacttttggcccagttgaaagagtaagaaaaagggtactgctaaaccctctcactaaggaaatgcctccagatgaagcaagtaatgtgataatggaaatattgttccctaaggaagcaggaataccaagagaatctacttggatacatagggaactgataaaagaaaaaagagaaaaattgaaaggaacgatgataactcccattgtactggcatacatgcttgagagggaattggttgccaggagaaggttcctgccggtggcaggagcaacatcagctgagttcatagaaatgctacactgcttacaaggtgaaaattggagacaaatataccacccgggagggaataaactaactgaatctaggtctcaatcgatgattgtggcttgtagaaagataatcagaagatcaatagtcgcatcaaacccattggagctggctgtagaaattgcaaacaagactgtgatagatactgaacctttaaaatcatgtctgacagccatagacggaggtgatgtcgcctgtgacataataagagctgcattaggactaaagatcagacaaagacaaagatttggacgacttgaactaaaaaggatatcaggaagaggattcaaaaatgatgaagaaatattaatcgggaacggaacaatacagaagattggaatatgggacggagaagaggagttccatgtaagatgtggtgaatgcaggggaatattaaaaaagagcaaaatgagaatggaaaaactactaataaattcagctaaaaaggaagacatgaaagatttaataatcttgtgcatggtattttctcaagacactaggatgttccaaggagtaaggggagaaataaattttcttaatagagcaggccaacttttatctccaatgtaccaactccaaagatattttttgaatagaagtaacgatctctttgatcaatgggggtatgaggaatcacccaaagcaagtgagctacatgggataaatgaattaatgaatgcatctgactacactttgaaaggggttgtagtaacaaaaaatgtgattgatgattttagttctactgaaacagaaaaagtatctataacaaaaaatcttagtttaataaaaagaactggggaagtcataatgggggccaatgacgtaagtgaattagaatcacaagctcagctaatgataacatatgatacacctaagatgtgggagatgggaacaaccaaagaactggtgcaaaacacctatcaatgggtgctaaaaaatttggtaacactgaaggctcagtttcttctaggaaaagaagacatgttccaatgggatgcatttgaagcatttgaaagcataatcccccagaagatggctggccaatacagtggatttgcaagagcagtgctcaaacaaatgagagaccaagaggtcatgaaaactgaccagttcataaagttgttgcccttttgtttctcaccaccaaagttaaggagcaatggggagccttatcagttcttgaggcttgtattgaagggaggaggagaaaatttcatcgaagtaaggaaagggtctcctctattctcttacaatccacaaacagaagtcctaactatatgcggcagaatgatgtcattaaaagggaaaattgaagatgaagaaaggaatagatcaatggggaatgcagtgttggcgggttttcttgttagtggcaagtatgacccagatcttggagatttcaaaactattgaagaacttgaaaagctaaaaccgggggagaaagcaaacatcttactttatcaaggaaagcccgttaaagtagttaaaaggaaaagatatagtgctttatccaatgacatttcacaaggaattaagagacaaagaatgacagttgagtccatggggtgggccttgagctaatataaatttatccattaattcaataaacacat

SEQ ID NO: 39 - DNA, 2331 bp, Influenza B virus
cgagcctttaagatgaatataaatccttattttctcttcatagatgtacccatacaggcagcaatttcaacaacattcccatacaccggtgttcccccttattcccatggaacgggaacaggccacacaatagacaccgtgatcagaacacatgagtactcgaacaaaggaaaacagtatgtttctgacatcacaggatgtacaatggtagatccaacaaatggaccattacccgaagacaatgagccaagtgcctatgcacaattagattgcgttctggaggctttggatagaatggatgaggaacatccaggtctgtttcaagcagcctcacagaatgccatggaggcactaatggtcacaactgtagacaaattaacccaggggagacagacttttgattggacagtatgcagaaaccagcctgctgcaacggcactaaacacaacaataacctcctttaggttgaatgatttgaatggagctgacaagggtggattggtacccttttgccaagatatcattgattcattggacaagcctgaaatgactttcttctcagtaaagaatataaagaaaaaattgcctgctaaaaacagaaagggtttcctcataaagagaataccaatgaaagtaaaagacaggatatccagagtggaatacatcaaaagagcattgtcattaaacacaatgacaaaagatgctgaaaggggcaaactaaaaagaagagcgattgcaaccgctggaatacaaatcagagggtttgtattagtagttgaaaacttggctaaaaatatctgtgaaaatctagaacaaagtggtttgcccgtaggtggaaatgaaaagaaggccaaactgtcaaatgcagtggccaaaatgctcagtaactgcccaccaggagggatcagcatgacagtaacaggagacaatactaaatggaatgaatgcttaaatccaagaatctttttggctatgactgaaagaataaccagagacagcccaatttggttccgggatttttgtagtatagcaccggtcttgttctccaataaaatagccagattgggaaaaggatttatgataacaagtaaaacaaaaagactgaaggctcaaataccttgtcctgatctgtttagcataccattagaaagatataatgaagaaacaagggcaaaattaaaaaggctgaaaccattcttcaatgaagaaggaacggcatctttgtcgcctggaatgatgatgggaatgtttaatatgctatctaccgtgttgggagtagccgcactaggtatcagaaacattggaaacaaagaatacttatgggatggactgcaatcttctgatgattttgctctgtttgttaatgcaaaagatgaagagacatgtatggaaggaataaacgacttttaccgaacatgtaaattattgggaataaacatgagcaaaaagaaaagttactgtaacgaaactggaatgtttgaatttacaagcatgttctatagagatggatttgtatctaactttgcaatggaaattccttcatttggagttgctggagtaaatgaatcagcagatatggcaataggaatgacaataataaagaacaatatgattaacaatgggatgggtccagcaacagcacaaacagccatacaattgttcatagctgattataggtacacctacaaatgccacagaggagattccaaagtggaaggaaaaagaatgaaaattataaaggagctatgggaaaacactaaaggaagagatggtctgttagtggcagatggtgggcccaacatttacaatttgagaaacttacatatcccagaaatagtattgaagtacaatctaatggaccctgaatataaagggcggttacttcatcctcaaaatccctttgtaggacatttgtctattgaaggcatcaaagaagcagatataaccccagcacatggtcccgtgaagaaaatggattatgatgcagtgtctggaactcatagttggagaaccaaaaggaacagatctatactaaatactgatcagaggaacatgattcttgaggaacaatgctacgctaagtgttgcaatctttttgaggcctgttttaacagtgcatcatacaggaaaccagtaggccagcacagcatgcttgaggctatggcccatagattaagaatggatgcacgactagattatgaatcaggaagaatgtcaaaggatgattttgagaaagcaatggctcaccttggtgagattgggtacatataagtgtcaaaggatgattttgagaaagcaatggctcaccttggtgagattgggtacatataa

SEQ ID NO: 40 - DNA, 1125 bp, Influenza C virus
atggcacatgaaatactgattgctgaaacagaggcatttctaaaaaatgttgctcctgagaccaggacagcaataatttcagcaataacaggaggaaaatcagcctgcaaatcagcagctaaactgattaagaatgaacatcttcccctaatgtctggagaagccaccacaatgcacatcgttatgaggtgcttatatcctgaaataaaaccatggaaaaaggcaagcgacatgctgaataaagcaacttctagtttgaaaaaatcagaaggaagagacataagaaagcaaatgaaagcagctggagacttcttgggagtggagtcaatgatgaaaatgagggccttcagagatgaccaaataatggaaatggttgaagaagtatatgatcacccagacgactacacaccagacatccgaataggaacaatcacagcttggttgagatgcaaaaacaagaaaagtgaaagatacaggagtaatgtctcagaaagtggaagaacagctttaaaaattcatgaagtaagaaaagccagcacagcaatgaacgagattgctggtattactggccttggagaagaagcactatctctccaaagacaaacagaaagtttggccatattatgtaatcacacttttggaagtaatataatgagaccccacttggaaaaagcaataaaaggagttgaaggcagagttggagagatgggacgaatggcaatgaaatggttagttgttataatatgtttctctataacaagtcaacctgcttctgcttgcaatctaaagacctgtctaaaactatttaacaatactgatgcggtaactgttcattgttttaatgaaaaccaaggatacatgctaacattagcctctttgggattagggataattactatgttgtatttattagtaaaaatcataattgaacttgtcaatggttttgtgctcggcagatgggagagatggtgtggagatataaagaccacaattatgcctgaaattgactcgatggaaaaagatattgccctttctagggagagacttgacctgggagaggatgctcctgacgaaaccgacaactcaccaattcctttttccaatgatggtatttttgaaatttaa

SEQ ID NO: 41 - DNA, 1807 bp, Influenza C virus
agcagaagcaggagatttgattttcaaaaatgtctgacagacgtcaaaacagaaagacgccagatgagcaacgcaaagccaatgctctcataataaatgagaacattgaagcctacattgccatttgtaaggaagtgggccttaatggcgatgaaatgttgatcctggaaaatggcatagcaattgaaaaagctataagaatatgttgtgatggaaagtatcaggaaaaaagggaaaagaaagcaagagaagcccaaagagcggacagcaacttcaatgcagattccattgggatcagactagttaaaagagctggttcaggcaccaatataacctaccatgcagttgttgaattgacaagccgctcaagaattgttcaaattctcaaatctcattggggaaatgaactaaacagagcaaaaattgcaggaaaaagactcggcttctctgcactctttgcttctaacttagaagcaattatttatcaaagaggaagaaatgcagcaagaagaaacggttctgctgaattgttcactctcactcaaggggctggaatcgaaactagatataaatggataatggaaaagcacatcggaattggagttcttatagctgacgcaaaaggtttaataaatggaaagagagaaggcaaaagaggagttgatgccaatgtaaaattgagagcaggaacgactggttcccctctggaaagagccatgcaaggaattgagaaaaaagcgtttcctgggcctttaagagcactagcaagaagagttgtaaaagcaaactacaatgatgccagagaagctctaaatgtcatcgcagaagcatcactcctgttaaagcctcagataaccaacaagatgacaatgccttggtgtatgtggttggctgccagacttactctgaaagatgagtttgccaatttctgtgcatatgcaggaagaagagcctttgaagtcttcaatattgcaatggagaaaattggaatttgttcctttcaagggacaataatgaacgatgatgaaattgaatcaatagaggacaaggctcaagtattaatgatggcatgctttggacttgcttatgaagacttcagtttggtctctgctatggttagccaccctcttaagttgagaaacagaatgaaaataggaaacttcagagtcggtgaaaaagtttcaacagtgctttctcccttattgagattcacaagatgggcagagtttgctcaaagatttgctcttcaggcaaatacttcaagagaaggcgctcaaatcagcaattcagcagtttttgcagtggaaaggaagataaccacagatgtccaaagagttgaagagctactaaataaagttcaagctcatgaagatgaaccattacaaacactttacaaaaaagtaagagaacaaatttccataattggaaggaacaagtctgaaataaaggagtttctagggtcttcaatgtatgatttaaatgatcaagaaaaacaaaatccaataaatttcaggtctggagcacaccctttctttttcgaattcgacccagactacaaccccataagagtgaaaagacccaaaaaaccaatagcaaagagaaattcaaatatcagcagattggaagaagaaggaatggatgaaaattcagagattggacaagccaagaagatgaaacctttggatcaattgaccagcactagtagcaacattcctggaaaaaattaaagtcagattaaattcatcacatattttatgatcaactgttgtattgctatatataattcaaaaatctccttgctactgct

SEQ ID NO: 42 - DNA, 1968 bp, Influenza C virus
atgtttttctcattactcttgatgttgggcctcacagaggctgaaaaaataaagatatgccttcaaaagcaagtgaacagtagcttcagcctacacaatggcttcggaggaaatttgtatgccacggaagaaaaaagaatgtttgagcttgttaagcccaaagctggagcctctgtcttgaatcaaagtacatggattggctttggagattcaaggactgacaaaagcaattcagcttttcctaggtctgcggatgtttcagcaaaaactgctgataagtttcgttctttgtctggtggatccttgatgttgagtatgtttggaccacctgggaaggtagactacctttaccaaggatgtggaaaacataaggttttttatgaaggagttaactggagtccacatgctgctataaattgttacagaaaaaattggactgatatcaaactgaatttccagaaaaacatttatgaactggcttcacaatcacattgcatgagcttggtgaatgccttggacaaaactattcctttacaagcgactgcaggggttgcaaaaaattgcaacaacagcttcttaaaaaatccagcattgtacacacaagaagtcaatccttcagtagaaaaatgtgggaaagaaaatcttgctttcttcacacttccaacccaatttggaacctatgagtgcaaactgcatcttgtggcttcttgctatttcatctatgatagtaaagaagtgtacaataaaagaggatgtgacaactactttcaagtgatctatgattcatctggaaaagttgttggaggactagataacagggtatcaccttacacagggaattctggagacaccccaacaatgcaatgtgacatgctccagctgaaacctggaagatattcagtaagaagctctccaagattccttttaatgcccgaaagaagttattgctttgacatgaaagaaaaaggaccagtcactgctgtccaatccatttggggaaaaggcagagaatctgaccatgcagtggatcaagcttgcttgagcactccagggtgcatgttgatccaaaagcaaaagccatacattggagaagctgatgatcaccatggagatcaagaaatgagggagttgctgtcaggactggactatgaagctagatgcatatcacaatcagggtgggtgaatgaaaccagcccttttacggaagaatacctccttcctcccaaatttggaagatgccccttggctgcaaaggaagaatccattccaaaaatcccagatggccttctaattcccaccagtggaactgataccactgtaaccaaacctaagagcagaatttttggaatcgatgacctcattattggtttgctctttgttgcaatcgttgaagcaggaattggaggctatctgcttggaagtagaaaagtatcaggaggaggtgtgacaaaagaatcagctgaaaaagggtttgagaaaattggaaatgacatacaaatcctaagatcttctacaaatatcgcaatagaaaaactgaatgacagaatttctcatgatgagcaagccatcagagatctaactttagaaattgaaaatgcaagatctgaagctttgttaggagaattgggaataataagagccttgttggtaggaaatataagcataggattacaagaatctttatgggaactagcttcagaaataacaaatagagcaggagatctagcagttgaagtctctccaggttgctgggtaattgacaataacatttgtgatcaaagttgtcaaaactttattttcaagttcaacgaaactgcacctgttccaaccattccccctcttgacacaaaaattgatctgcaatcagatcctttttactggggaagcagcttgggcttagcaataactgctgctatttcattggcagctttggtgatctctgggatcgccatctgcagaactaaatga

SEQ ID NO: 43 - DNA, 2130 bp, Influenza C virus
atgtcaaaaacttttgccgaaatagcagaggcttttctagagccagaagctgtaagaatagccaaagaagcagtagaagaatatggggatcacgaaagaaaaataatacaaattggaatacactttcaagtttgctgcatgttctgtgatgagtatttgagtacaaatgggagtgatagatttgtgctcattgaaggaagaaaaagaggaactgcagtgtctttacaaaatgagctatgtaaaagttatgatcttgaaccactaccttttctttgtgacatttttgacagggaggaaaaacaattcgttgaaattggaataacaagaaaagcagatgatagctattttcaatccaagtttggtaaacttggaaatagctgcaagatatttgtattctcctatgatggaagattagacaaaaattgtgaaggccctatggaggaacaaaaattgagaattttcagttttcttgcaactgctgctgattttcttaggaaagaaaacatgtttaacgaaatcttcttaccagacaatgaagaaaccatcattgaaatgaagaaaggaaaaacatttctaaaattgagggatgaaagtgttcctttaccttttcaaacttatgaacagatgaaagattactgcgaaaaatttaaaggaaatccaagagaattagcttctaaagtaagccaaatgcaaagcaatattaaattaccaataaaacattatgagcagaataaatttcgacaaatacgtctaccaaagggaccaatggcaccctatacccacaagttcttaatggaagaagcatggatgtttacaaaaattagtgatccagaaagatcaagagctggtgaaattctcattgatttcttcaagaaagggaatctttctgcaatcagacccaaagacaaaccattacaagggaaatatcccatacattacaaaaatctttggaatcagattaaagcagcaattgccgatagaaccatggtaataaatgaaaatgatcattcagagtttctaggaggaattggaagagcctctaaaaagatcccagaggtttctctgacacaagatgtaataacaacagaaggattaaaacaatcagaaaataagttaccagaaccaagatctttccctaaatggttcaatgctgagtggatgtgggcaataaaagattctgaccttactggatgggtgcccatggcagaataccctcctgctgataatgaattggaagattacgctgaacatctaaataaaaccatggaaggggtcttgcaaggaacaaattgcgcaagagaaatggggaaatgcattcttactgttggggcactaatgactgaatgtagactatttcctgggaaaataaaagtggtgcccatatatgctagaagtaaagaaaggaaatcaatgcaagaagggcttccggtgccctcagaaatggactgtttatttggtatatgcgtcaagtcaaaatcacatttaaacaaggatgatggaatgtacacaataataacatttgaattctcaataagagagcctaatttagaaaaacatcaaaaatatactgtatttgaagcaggacacacaacagttagaatgaagaaaggagagtcagttattggaagagaagtccctctttatttatactgtaggacaactgccctttccaaaatcaagaatgactggctatcaaaggctagaagatgtttcatcacaactatggacacagtggaaaccatatgtctaagagagtcagcaaaggctgaagaaaatctagttgaaaagacattaaacgaaaaacagatgtggattgggaagaaaaatggagagttaattgctcaacctttaagagaagctttaagagtacagctggtacaacaattctatttctgcatctataatgacagtcaattagaaggcttttgtaatgagcagaagaaaatcctaatggctcttgaaggtgacaagaaaaataaatcatcttttggatttaatccagaaggattattagaaaagattgaagagtgtcttataaataatccgatgtgcctttttatggctcaaaggttgaatgaacttgtaattgaggcctcaaaaagaggcgctaagtttttcaaaattgattga

SEQ ID NO: 44 - DNA, 2265 bp, Influenza C virus
atggaaatcaacccatatttgatgtttctaaacaacgacgtcacatcgctgatatcaacaacatacccctatacagggccacctccaatgtcacatggatcatcaaccaaatacactttggaaactattaaaagaacatatgactactcaagaacatcagttgaaaaaacatcgaaagttttcaatataccaagaagaaagttttgcaattgtcttgaagacaaagatgagttggtaaaaccaacaggaaacgttgatatcagttccttgttgggccttgcagagatgatggagaaaagaatgggggaaggattttttaagcattgtgtaatggaggcagaaacagaaatacttaaaatgcacttctctagacttacggaaggaagacaaacatatgattggacttctgaaagaaacatgccagcggccactgctttgcaactgacagttgatgccataaaagaaacagaaggaccatttaaagggacaacaatgcttgaatattgcaataaaatgatagaaatgcttgattggaaagaagttaaattcagaaaagtcaaaacaatggtgagaagggagaaagataaaagaagtgggaaggagataaaaactaaagtacctgtaatgggaattgactcaattaaacatgatgagtttttaattagagcattaactattaataccatggccaaagatggggaaagagggaaattgcaaagaagagcaattgcaacacccggtatgatagtaagaccattttcaaaaattgttgaaactgtagcacagaaaatatgtgagaaattgaaagaaagcggtctacctgttggtggtaatgagaagaaagcaaaacttaagactactgttacttctctcaatgccaggatgaacagtgatcagtttgcagttaatataactggagacaatagtaaatggaatgaatgccaacaacctgaggcttatttagcacttttggcttacatcaccaaagactcctctgatttaatgaaagacttatgcagtgttgctccagtgcttttctgtaataagtttgtgaaacttggacaaggaataagactttcaaataaaagaaaaacaaaggaagtcataataaaagctgagaaaatgggaaaatacaagaatctaatgagagaagaatataaaaacctttttgaacccttagagaaatatattcagaaggatgtctgttttttacctggaggaatgcttatgggaatgttcaacatgctgtcaacagttcttggagtaagtacattatgttatatggatgaagaactaaaagccaaaggatgtttttggactggactccaatcttctgatgactttgttctttttgcagttgcttcaaactggtcaaatatacattggacaataagacggtttaatgctgtatgcaagttaattggtataaacatgtctcttgaaaaatcgtatggttctctcccagaactctttgaatttacaagtatgttctttgatggagaatttgtgtccaatcttgctatggaattgccagctttcactactgcaggagttaatgaaggagttgattttacagctgcaatgtcaattattaagacaaatatgataaataacagcttatcaccttctactgctttaatggccttaaggatatgtctccaagaatttagagcgacttatagagtccatccttgggattcaagagtgaaaggtgggagaatgaaaataataaatgagttcataaaaaccatagaaaataaagatggattattaattgctgatggtgggaaactgatgaacaacattagcacccttcatattcctgaggaagtactgaagtttgaaaaaatggatgaacaatatagaaatagggtattcaaccccaaaaatccctttactaactttgacaaaactattgatatatttagagcacatggcccaataagggttgaagaaaatgaagcagtagtttcaactcatagcttcagaactagagcaaacagaaccctattgaatacagatatgagagcaatgatggcagaagagaaaagatatcaaatggtttgcgacatgtttaaaagcgtgtttgaatcagcggacataaatcctccaattggggctatgagcattggagaggccatagaagaaaaactattagagagagctaaaatgaaaagagacattggggcaatagaagattcagaatatgaagaaataaaagacattataagggatgcaaagaaagctagaattgaaagtagatga

SEQ ID NO: 45 - DNA, 2325 bp, Influenza C virus
atgtcttttctattgacaatagcaaaggaatacaaaagactatgccaagatgctaaggcagctcaaatgatgacagtaggaactgtatcaaactacactacgttcaagaaatggactacatcaaggaaggaaaagaatccttcactaagaatgagatgggcaatgagcagcaaattcccaataatagctaacaagagaatgctggaagaagctcaaattcctaaagaacacaacaatgtagccctttgggaagacacagaagatgtttcaaaaagggatcatgttcttgcaagcgcctcttgtataaattattggaatttttgtggaccttgtgtcaacaattcagaagtgatcaaagaagtttataaatctagatttggaagattagaaagaaggaaagaaataatgtggaaagaacttagatttacattagttgatagacaacgaagaagagttgacactcagcctgtagaacaaagattgagaactggagaaattaaagacttgcaaatgtggactttgttcgaagatgaagctcctcttgctagcaaatttattttagacaattatggtctagtcaaagaaatgagatcaaagtttgcaaacaaacctctgaataaagaagtagttgcacacatgttagaaaaacaattcaatccggaaagtagattcttgcctgttttcggagctataaggccagaaagaatggaattgatccatgcattaggaggagaaacttggatacaagaagctaacactgcagggatttccaatgttgatcaaaggaaaaatgatatgagagcagtatgtaggaaagtttgtcttgcagcaaatgcaagtataatgaacgccaaaagcaaactggttgagtatataaaaagtacaagtatgagaattggagaaacagaaagaaagcttgaagaacttatacttgaaaccgatgatgtctcacctgaagtaacattatgtaaatctgctttaggaggaccattaggaaaaactctatcttttgggcccatgctactcaagaaaatttctggttccggagtaaaagttaaagatacagtatatatccaaggtgtcagagcagtacaatttgaatactggagtgagcaagaagaattctatggagaatataagtcagccaccgctttattcagcagaaaggaaagatcactagaatggattacaataggaggaggaataaatgaagacagaaagagacttctagctatgtgcatgatattttgcagagatggagattattttaaagacgcccctgcaacaataacaatggcagatttaagtacgaagttaggaagagaaattccatatcaatatgtgatgatgaattggatacaaaaatcagaagataatctcgaagccttattatacagtaggggaattgtagaaaccaatccaggaaaaatggggagctcaatgggaattgatggttccaaaagagcaattaaatctttaagggctgtcacaatacaatcaggaaagattgacatgccagaatcaaaagaaaaaattcaccttgagctctctgataatcttgaagcatttgattcatcaggaagaattgttgcaacaattttagaccttcctagtgacaaaaaggtaacatttcaggatgtaagctttcaacatcctgatctggcagtattgagagatgagaaaacggccataacaaaagggtatgaagcgctaatcaaaaggctaggaacaggggacaatgatattccttccttaattgcaaagaaggattatttgtctctttataatttaccagaagtaaaattaatggctcccttaatcagacccaatagaaaaggagtttattccagagttgctagaaaattagtgtctacacaagttactactggacattattcattacatgaattgataaaggtcttaccctttacttatttcgccccaaaacagggaatgtttgaaggaaggcttttctttagcaacgatagctttgttgagcctggagtaaataacaatgtattttcttggagtaaggctgacagttctaaaatatattgtcatggaatagcgataagggtacctttagttgttggagatgaacacatggacacttcgttagcactattagaagggtttagtgtttgtgaaaacgaccccagagcaccaatggtaacaagacaagatttaattgatgtgggatttgggcaaaaagttagactcttcgtaggccaagggagcgttagaaccttcaagcgaactgcctcacaaagggctgcatcaagcgatgtaaataagaatgtgaaaaagataaagatgtctaactaa

SEQ ID NO: 46 - DNA, 881 bp, Influenza C virus
aaaatgtccgacaaaacagtcaaatcaacaaatttaatggcatttgtagccacaaaaatgttagagagacaagaagatttagacacatgcactgaaatgcaagtagaaaaaatgaagacgtcaacaaaagccaggttgagaacagaatcctcttttgcacctagaacatgggaagatgcgataaaagatggtgagcttctattcaacgggacgattctgcaagcagagtctcctacaatgacgccagcgtccgtagaaatgaaggggaagaaatttcctattgattttgctccaagcaacatagcaccaattgggcaaaatccaatatatttgtcaccatgtattcctaactttgatggaaacgtctgggaagcaacgatgtatcatcatcgtggagcaactttgacaaagacaatgaattgcaactgttttcaaaggacaatttggtgccatccaaatccttcacgtatgagattgagctatgcatttgttttgtattgcagaaatactaagaagatctgtggatacctcatcgctaaacaagtggccggaattgaaacaggaattagaaaatgtttcagatgcattaaaagcggattcgttatggctaccgatgaaatctctctcactatactccaaagtatcaaatcaggagcccagctcgatccctattggggaaatgaaacaccagatattgacaagactgaagcttatatgctctcgcttagagaagctggaccttaacctgagcaaagcagtcttaggaatccaaaattctgaagatcttattttgatcatatataacagagatgtttgtaaaaacactatattaatgataaaatctttgtgtaattcacttatataattgttctaagttgtta

SEQ ID NO: 47 - DNA, 24 bp, Artificial
  primer sequence
gtttcccagtcacgatannnnnnn

SEQ ID NO: 48 - DNA, 17 bp, Artificial
  primer sequence
gtttcccagtcacgatc

(19) United States
(12) Patent Application Publication
(10) Pub. No.: US 2009/0088331 A1
(43) Pub. Date: Apr. 2, 2009

(54) INFLUENZA VIRUS NUCLEIC ACID MICROARRAY AND METHOD OF USE

(75) Inventors: Xiaolin Wu, Gaithersburg, MD (US); Cassio S. Baptista, Frederick, MD (US); David J. Munroe, Frederick, MD (US)

Correspondence Address: EDWARDS ANGELL PALMER & DODGE LLP, PO BOX 55874, BOSTON, MA, 02205, US

(73) Assignee: Government of the United States of America, as represented by the Secretary, Dept. of Health and, Rockville, MD (US)

(21) Appl. No.: 11/936,530

(22) Filed: Nov. 7, 2007

Related U.S. Application Data
(60) Provisional application No. 60/857,695, filed on Nov. 7, 2006.

(51) Int. Cl. C40B 30/04; C40B 40/06

(52) U.S. Cl. 506/9; 506/16

(57) ABSTRACT

The present invention relates generally to methods of detecting and identifying known and unknown viruses using hybridization microarrays to essentially all known influenza virus nucleotide sequences of at least one type that infect at least one species, the sequencing of nucleotides which hybridize to the microarrays and analysis of the hybridized sequences with existing databases, thus identifying existing or new subtypes of viruses. The present invention also relates to methods of use of the microarrays of the invention for the detection of influenza viruses, including variant influenza viruses. The method includes the use of a non-specific PCR amplification method to amplify sample nucleic acids.

### REFERENCE TO RELATED APPLICATIONS

This application claims priority to U.S. Provisional Patent Application Ser. No. 60/857,695 filed on Nov. 7, 2006 and PCT Patent Application Serial No.: PCT/US2007/010792 filed on May 2, 2007, both of which are incorporated herein in their entirety.

### STATEMENT OF FEDERALLY SPONSORED RESEARCH

Research supported in this application was carried out by the United States of America as represented by the Secretary, Department of Health and Human Services.

### SEQUENCE LISTING

A sequence listing is provided herewith to comply with the requirements for Sequence Listings and is incorporated herein by reference.

### FIELD OF THE INVENTION

The present invention relates to the use of influenza virus nucleic acid microarrays for the identification of existing and new subtypes of mammalian and avian influenza viruses.

### BACKGROUND OF THE INVENTION

There are three types of influenza viruses, type A, B and C. Influenza A is known to infect birds, pigs, horses, seals, whales, and humans. Influenza B is known to infect humans and seals. Influenza C is known to infect humans and pigs.

Influenza A or B viruses cause epidemics of disease almost every winter, with type A causing a major pandemic periodically. Influenza C can also infect humans but is more rare than A or B. In humans, common symptoms of influenza infection are fever, sore throat, muscle pains, severe headache, coughing, weakness and general discomfort. In more serious cases, influenza causes pneumonia, which can be fatal, particularly in young children and the elderly. Typically, influenza is transmitted from infected mammals through the air by coughs or sneezes, creating aerosols containing the virus, and from infected birds through their droppings. Influenza can also be transmitted by saliva, nasal secretions, feces, and blood. Infections also occur through contact with these body fluids or with contaminated surfaces.

Influenza type A viruses are divided into subtypes based on two proteins on the surface of the virus. These proteins are called hemagglutinin (H) and neuraminidase (N). There are 16 known HA subtypes and 9 known NA subtypes of influenza A viruses. Each subtype may have different combinations of H and N proteins. Although there are only three known A subtypes of influenza viruses (H1N1, H1N2 and H3N2) currently circulating among humans, many other different strains (e.g., H1N1, H1N2, H2N2, H3N1, H3N2, H3N8, H5N1, H5N2, H5N3, H5N8, H5N9, H7N1, H7N2, H7N3, H7N4, H7N7, H9N2, H10N7) have been identified or are circulating among birds and other animals and these viruses do spread to humans occasionally (e.g., H5N1).

Influenza viruses are RNA viruses; therefore, the viruses do not include a mechanism for proofreading or repair of errors arising during replication. This results in a relatively high mutation rate in influenza viruses, about one base per replication per viral genome. Influenza viruses can also change rapidly due to recombination when more than one virus particle infects a cell. This high rate of mutation, recombination, and variation results in the need for annual vaccination of individuals against the particular strains of flu present or expected to be prevalent each year.

The gold standard for identification of viruses has long been culturing of viruses to obtain sufficient material to allow for identification by sequencing or other methods. Culturing of viruses requires an appropriate host and is time consuming (typically 3 to 7 days), often delaying the identification of the virus until after the optimal time for treatment has passed. A number of methods such as those based on the polymerase chain reaction (PCR), immunoassays, and nucleic acid microarrays have been developed for the detection of single pathogens, such as viruses (e.g., see US Patent Publication 20070184434).

Microarray methods have been developed to identify influenza viruses using (see, e.g., Townsend et al., J. Clin. Microbiol. 44:2863, 2006; Sengupta et al., J. Clin. Microbiol. 41:4542, 2003;).

### SUMMARY OF THE INVENTION

The present invention relates generally to influenza virus nucleic acid microarrays and methods of detecting and identifying known and unknown influenza viruses using the microarrays containing substantially all nucleotide sequences of at least one type (A, B, or C) of influenza virus that infect at least a single host species (e.g., human, bird, horse, pig, seal). The methods can further include the sequencing of nucleic acids that hybridize to the microarrays and analysis of the hybridized sequences with existing nucleotide sequence databases, thus identifying existing or new subtypes or mutations of influenza viruses.

More specifically, the present invention relates to microarrays comprising a surface with a plurality of n-mer nucleotides capable of hybridizing to substantially all nucleotide sequences known at the time of filing of at least one type of influenza virus that infects at least a single host species. The n-mer oligonucleotides are designed to tile substantially all nucleotide sequences known at the time of filing of at least one type of influenza virus that infects at least a single host species. In a preferred embodiment, the plurality of n-mer viral nucleotides are comprised of nucleotide sequences from substantially all known influenza viruses of at least one type of influenza virus that infect at least a single host species. Sequences for substantially all known influenza viruses can be obtained from nucleotide sequence databases. Accession numbers corresponding to sequences of substantially all known influenza viruses of types A, B, and C obtained from the National Center for Biotechnology information are provided in Table 1. From the sequences of substantially all known influenza viruses, specific viral sequences can be identified for use in the microarrays and methods of the instant invention.

The invention further relates to methods for identifying known and unknown subtypes of mammalian and avian influenza viruses using the microarrays of the invention.

More specifically, the present invention relates to a method for identifying known and unknown subtypes of mammalian and avian influenza viruses comprising the steps of:

obtaining nucleotide sequences of substantially all influenza viruses of at least one type of influenza virus that infects at least a single host;

obtaining a microarray of the invention comprising a plurality of n-mer nucleotides designed to tile substantially all nucleotide sequences known at the time of filing of at least one type of influenza virus that infects at least a single host on a surface for hybridizing to substantially all of at least one type of influenza virus that infect at least a single host species;

isolating RNA from a sample suspected of containing an influenza virus nucleic acids, reverse transcribing the RNA into DNA, and labeling the DNA with a detectable marker;

contacting the labeled DNA from the sample with the support with immobilized influenza virus n-mer nucleotides, and incubating the support under conditions to permit hybridization of the labeled nucleic acids to the n-mer oligonucleotides attached to the support; washing the support;

detecting labeled DNA hybridized to the n-mer nucleotides;

identifying the sample nucleic acids based on the locations of the labeled DNA on the support; and optionally analyzing the sequences of the detected hybridized sample nucleic acids and comparing the sequences with a database to confirm the identity of the bound sequence or identify the influenza virus or new subtype virus. Analyzing can include, for example, sequencing or analysis of all of the sites at which the sample nucleic acid is hybridized, or both. Nucleotide sequences of influenza viruses can be obtained from nucleotide sequence databases or by using the Accession numbers provided in Table 1. Reverse transcription of the RNA, amplification and labeling of the nucleic acid is performed using a non-specific PCR method to allow for the amplification of all sequences in a non-biased fashion. This allows for the detection of variant and previously unidentified and/or non-conserved viral sequences.

The invention further relates to methods for detection and identification of an influenza virus in a biological sample or subject using the microarray of the invention. For example the methods include diagnosing a patient with an influenza virus infection comprising the method of:

obtaining nucleotide sequences of substantially all influenza viruses of at least one type of influenza virus that infects at least a single host;

obtaining an array of a plurality of n-mer nucleotides on a surface designed to tile substantially all nucleotide sequences known at the time of filing of at least one type of influenza virus that infects at least a single host on for hybridizing to substantially all of at least one type of influenza virus that infect at least one species;

preparing RNA from a sample containing or suspected of containing an influenza virus, reverse transcribing the RNA, and labeling the reverse transcribed DNA with a detectable marker; applying the labeled DNA from the sample to the surface with the immobilized known conserved and non-conserved n-mer viral nucleotides designed to tile substantially all nucleotide sequences of at least one type of influenza virus that infects at least a single host;

and incubating under conditions to permit hybridization of said labeled DNA thereto;

detecting hybridization of the labeled nucleic acids and identifying the virus present by the position of the bound labeled nucleic acids on the array. The methods may further comprise and analyzing the sequences of the detected hybridized nucleic acids and comparing the sequences with a database to identify the influenza virus or new subtype virus wherein the virus is identified. The invention also includes detection and identification in biological samples such as tissue culture lines, animal colonies, livestock, and viral stocks for the preparation of vaccines or other purposes. Nucleotide sequences of influenza viruses can be obtained from nucleotide sequence databases or by using the Accession numbers provided in Table 1.

The invention relates to methods for detection of contaminants in viral stocks and cell lines, including screening and monitoring of stocks for the presence of contaminants. The method includes isolating RNA from viral or cells stocks, reverse transcribing the RNA to DNA, labeling the DNA, contacting the labeled DNA with a microarray of the invention, and detecting the presence of a labeled DNA hybridized to the array per the methods of the invention. Such methods can be used for the detection of variations in viral stocks, such as those used for the generation of vaccines. Variants and variations include spontaneous mutations, point mutations or recombinations, for example with the host genome, and contaminants in viral stocks. Viral stocks can be assayed for the presence of contaminants on a regular, periodic basis, or sporadically.

The invention further relates to methods to detect genetic drift in a viral population to determine the presence or rates of mutation of one or more influenza viruses under various conditions. The method includes isolation of RNA from influenza viruses in culture or from samples from viral hosts including samples of tissue and/or bodily fluid or environmental samples; reverse transcribing the RNA to DNA; labeling the DNA; contacting the labeled DNA with a microarray of the invention; and detecting the presence of a labeled DNA hybridized to the array per the methods of the invention.

The methods may further comprise and analyzing the sequences of the detected hybridized nucleic acids and comparing the sequences with a database to identify the influenza virus or new subtype virus wherein the virus is identified. For example, spontaneous mutations and recombination, or treatment with antiviral therapeutics can result genetic drift in the development of alterations in the influenza virus sequence. Methods of detection of the invention can be applied to populations in the event of a large scale outbreak of infection, especially, for example, to detect novel influenza viruses generated by recombination of human and animal viruses, such as human and avian viruses. Such methods can also be applied to an individual to select optimal therapeutic interventions and avoid the generation of resistant strains. The method can further include sequencing or other methods of analysis to confirm the identity of the influenza virus sequences present in the sample.

### BRIEF DESCRIPTION OF THE FIGURES

FIG. 1 is a schematic drawing of the viral microarray workflow, involving nucleic acid extraction, Cy3 labeling, hybridization, washing, detection, and database analysis.

FIG. 2 is a schematic illustration of typing and subtyping with a genome tiling nucleotide array.

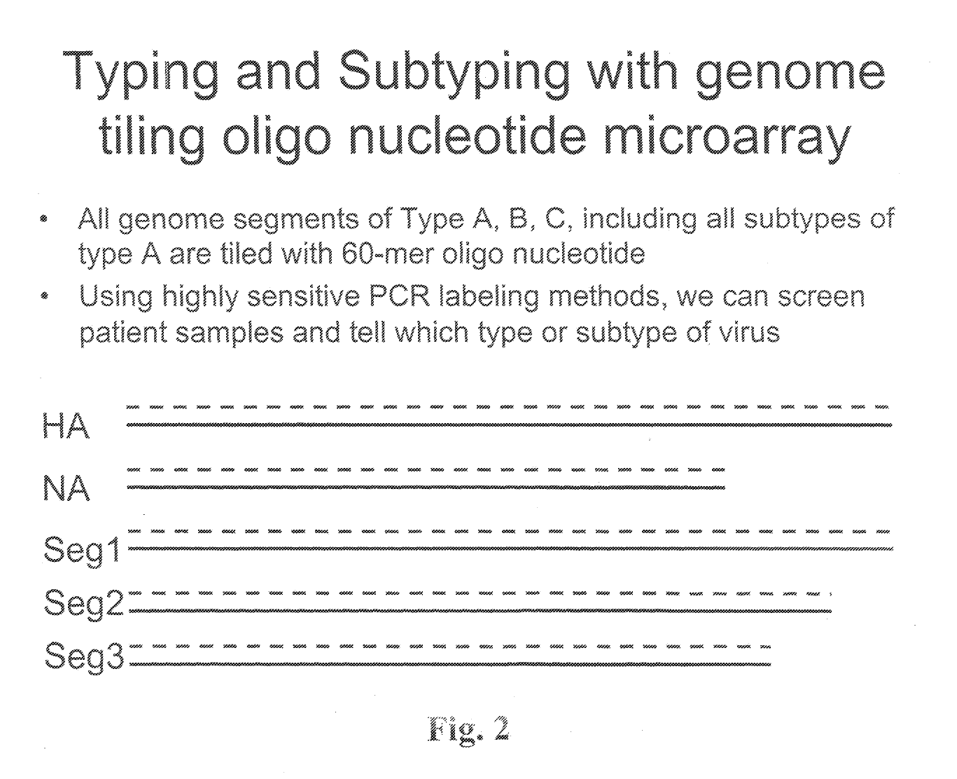

FIG. 3 is an illustration of the influenza microarray performance wherein cross-hybridization derived from influenza virus types and subtypes are visible, reflecting the successful representation on the array of identifying types and subtypes of influenza viruses present in FluMist, with a sensitivity down to 100 infectious units.

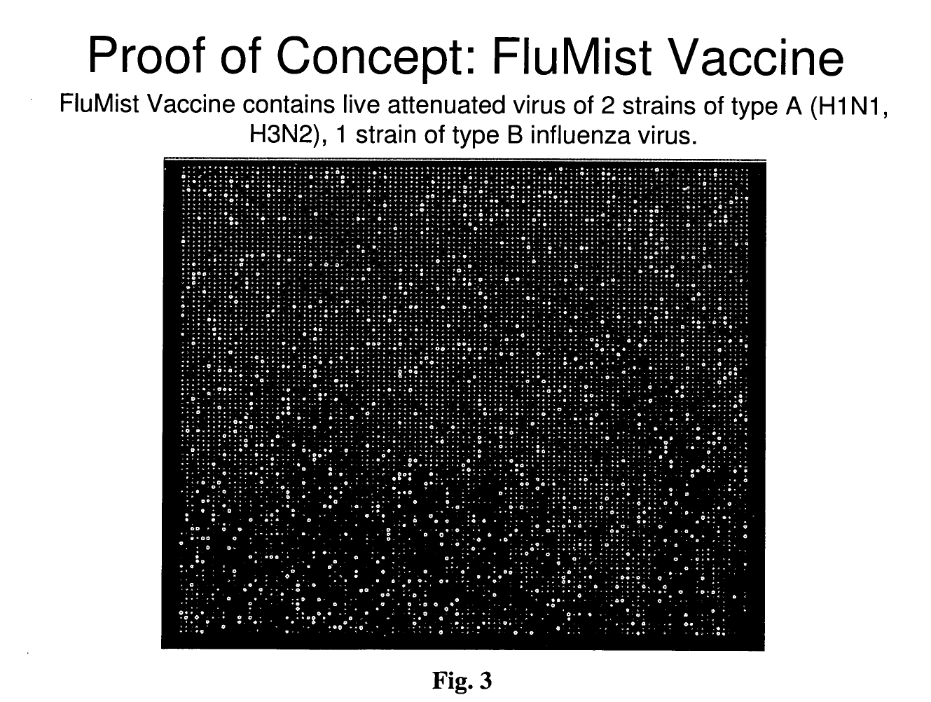

### DETAILED DESCRIPTION OF THE INVENTION

The rapid development of genomic databases, bioinformatics tools, and enabling technologies such as cDNA and oligonucleotide microarrays have provided new insights and understanding into biological and disease processes through the global analysis of nucleotide sequences. The present invention relates to microarrays for influenza virus detection. The viral microarray consists of a plurality of n-mer nucleotides capable of hybridizing to substantially all nucleotide sequences known at the time of filing of at least one type of influenza virus that infects at least a single host species. Nucleotide sequences of influenza viruses can be obtained from nucleotide sequence databases or by using the Accession numbers provided in Table 1.

In an embodiment, the microarray consists of a plurality of n-mer nucleotides capable of hybridizing to substantially all nucleotide sequences known at the time of filing of at least one type of influenza viruses that infects all bird species, all pig species, all horse species, all seal species, all whale species, the human species, any combination thereof, or all host species. The n-mer oligonucleotides are designed to tile substantially all nucleotide sequences of at least one type of influenza virus that infects at least a single host species. This design feature provides validation of results via redundant signals associated with each virus represented and also facilitates the discovery of “new” viruses that have arisen by recombination or mutation. Influenza virus sequences can be obtained from any nucleotide sequence database or combination thereof which include substantially all influenza virus nucleotide sequences. An example of substantially all influenza virus sequences available obtained from a nucleotide sequence database, specifically the NCBI database, are listed in Table 1. The sequence corresponding to each accession number in Table 1 is incorporated herein by reference. Exemplary sequences are provided in the sequence listing which are identified in the table below.

Each influenza virus has 8 genome segments, seg1 through seg8. In influenza A, most variations come from seg4 (HA, 16 major different seg4s) and seg6(NA, 9 major different seg6). One representative sequence was selected for each of the conserved segment, seg1, seg2, seg3, seg5, seg7, seg8. Representative sequences for each major variation for seg4 (x16) and seg6 (x9) were also selected.

One representative sequence was selected for each segment (1-8) of influenza B. One representative sequence was selected for each segment (1-7) of influenza C. No sequence for seg8 was found in NCBI database at the time of design.

TABLE 2
Representative Influenza virus sequences.

| | | SEQ |
|---|---|---|
| | | ID |
| Reference | Name | NO |
| gi\|8486138\|ref\|NC_002023.1\| | Influenza A virus segment 1, complete sequence | 1 |
| gi\|8486134\|ref\|NC_002021.1\| | Influenza A virus segment 2, complete sequence | 2 |
| gi\|8486136\|ref\|NC_002022.1\| | Influenza A virus segment 3, complete sequence | 3 |
| gi\|8486129\|ref\|NC_002019.1\| | Influenza A virus segment 5, complete sequence | 4 |
| gi\|8486122\|ref\|NC_002016.1\| | Influenza A virus segment 7, complete sequence | 5 |
| gi\|8486131\|ref\|NC_002020.1\| | Influenza A virus segment 8, complete sequence | 6 |
| gi\|77863433\|gb\|CY003761.1\| | Influenza A virus segment 4 (H1) (A/New | 7 |
| | York/400/2003(H1N2)), complete sequence | |
| gi\|73919144\|ref\|NC_007374.1\| | Influenza A virus segment 4 (H2) | 8 |
| | (A/Korea/426/68(H2N2)), complete sequence | |
| gi\|77917335\|gb\|CY003809.1\| | Influenza A virus segment 4 (H3) (A/New | 9 |
| | York/429/2000(H3N2)), complete sequence | |
| gi\|221313\|dbj\|D90302.1\|FLAHAH4N6 | Influenza A virus segment 4 (H4) | 10 |
| | (A/Duck/Czechoslovakia/56(H4N6)), complete cds | |
| gi\|78096575\|dbj\|AB239125.1\| | Influenza A virus segment 4 (H5) | 11 |
| | (A/Hanoi/30408/2005(H5N1)), complete cds | |
| gi\|221315\|dbj\|D90303.1\|FLAHAH6N5 | Influenza A virus segment 4 (H6) | 12 |
| | (A/Shearwater/Australia/1/72(H6N5)), complete cds | |
| gi\|66394847\|gb\|AY999991.1\| | Influenza A virus segment 4 (H7) | 13 |
| | (A/Mallard/Sweden/107/02(H7N7)), complete cds | |
| gi\|221317\|dbj\|D90304.1\|FLAHAH8N4 | Influenza A virus segment 4 (H8) | 14 |
| | (A/Turkey/Ontario/6118/68(H8N4)), complete cds | |
| gi\|77999548\|gb\|DQ227352.1\| | Influenza A virus segment 4 (H9) | 15 |
| | (A/chicken/Yunnan/Xie-1/1999(H9N2)), complete cds | |
| i\|324365\|gb\|M21647.1\|FLAMS84HA | Influenza A virus segment 4 (H10) | 16 |
| | (A/chick/Germany/N/49 (H10N7)), complete cds | |
| gi\|68137153\|gb\|DQ080993.1\| | A virus segment 4 (H11) | 17 |
| Influenza | (A/duck/Yangzhou/906/2002(H11N2)), complete cds | |
| gi\|221309\|dbj\|D90307.1\|FLAHAH12N | Influenza A virus segment 4 (H12) | 18 |
| | (A/duck/Alberta/60/76(H12N5)), complete cds | |
| gi\|221311\|dbj\|D90308.1\|FLAHAH13N | Influenza A virus segment 4 (H13) | 19 |
| | (A/Gull/Maryland/704/77(H13N6)), complete cds | |
| gi\|324046\|gb\|M35996.1\|FLAH14244 | Influenza A virus segment 4 (H14) | 20 |
| | (A/Mallard/Gurjev/244/82), | |
| gi\|1226070\|gb\|L43917.1\|FLAHEMAD | Influenza A virus segment 4 (H15) (A/shearwater/West | 21 |
| | Australia/2576/79(H15N9)), complete cds | |
| gi\|56425020\|gb\|AY684891.1\| | Influenza A virus segment 4 (H16) (A/black-headed | 22 |
| | gull/Sweden/5/99(H16N3)), complete cds | |
| gi\|78096577\|dbj\|AB239126.1\| | Influenza A virus neuraminidase gene (N1) | 23 |
| | (A/Hanoi/30408/2005(H5N1)), complete cds | |
| gi\|77999550\|gb\|DQ227353.1\| | Influenza A virus neuraminidase gene (N2) | 24 |
| | (A/chicken/Yunnan/Xie-1/1999(H9N2)), complete cds | |
| gi\|50542640\|gb\|AY646080.1\| | Influenza A virus neuraminidase gene (N3) | 25 |
| | (A/chicken/British | |
| | Columbia/GSC_human_B/04(H7N3)), complete cds | |
| gi\|37955294\|gb\|AY207533.1\| | Influenza A virus neuraminidase gene (N4) (A/gray | 26 |
| | teal/Australia/2/79(H4N4)), complete cds | |
| gi\|49357274\|gb\|AY633190.1\| | Influenza A virus neuraminidase gene (N5) | 27 |
| | (A/mallard/Alberta/203/92(H6N5)), complete cds | |
| gi\|37955342\|gb\|AY207557.1\| | Influenza A virus neuraminidase gene (N6) | 28 |
| | (A/sanderling/Delaware/1258/86(H6N6)), complete cds | |
| gi\|46981860\|gb\|AY531030.1\| | Influenza A virus neuraminidase gene (N7) | 29 |
| | (A/Mallard/64650/03(H5N7)), complete cds | |
| gi\|76153929\|gb\|DQ124151.1\| | Influenza A virus neuraminidase gene (N8) | 30 |
| | (A/canine/Florida/43/2004(H3N8)), complete cds | |
| gi\|49357324\|gb\|AY633390.1\| | Influenza A virus neuraminidase gene (N9) | 31 |
| | (A/teal/Alberta/16/97(H2N9)), complete cds | |
| gi\|30466244\|ref\|NC_004798.1\| | Influenza B virus (B/Memphis/12/97-MA) segment 8, | 32 |
| | complete sequence | |
| gi\|30466241\|ref\|NC_004797.1\| | Influenza B virus (B/Memphis/12/97-MA) segment 7, | 33 |
| | complete sequence | |
| gi\|30466238\|ref\|NC_004796.1\| | Influenza B virus (B/Memphis/12/97-MA) segment 6, | 34 |
| | complete sequence | |
| gi\|30466236\|ref\|NC_004795.1\| | Influenza B virus (B/Memphis/12/97-MA) segment 5, | 35 |
| | complete sequence | |
| gi\|30466234\|ref\|NC_004794.1\| | Influenza B virus (B/Memphis/12/97-MA) segment 4, | 36 |
| | complete sequence | |
| gi\|30466232\|ref\|NC_004793.1\| | Influenza B virus (B/Memphis/12/97-MA) segment 3, | 37 |
| | complete sequence | |
| gi\|30466230\|ref\|NC_004792.1\| | Influenza B virus (B/Memphis/12/97-MA) segment 2, | 38 |
| | complete sequence | |
| gi\|30466228\|ref\|NC_004791.1\| | Influenza B virus (B/Memphis/12/97-MA) segment 1, | 39 |
| | complete sequence | |
| gi\|52673229\|ref\|NC_006312.1\| | Influenza C virus segment 6, partial sequence | 40 |
| gi\|52630357\|ref\|NC_006311.1\| | Influenza C virus segment 5, complete sequence | 41 |
| gi\|52630355\|ref\|NC_006310.1\| | Influenza C virus segment 4, partial sequence | 42 |
| gi\|52630353\|ref\|NC_006309.1\| | Influenza C virus segment 3, partial sequence | 43 |
| gi\|52630351\|ref\|NC_006308.1\| | Influenza C virus segment 2, partial sequence | 44 |
| gi\|52630349\|ref\|NC_006307.1\| | Influenza C virus segment 1, partial sequence | 45 |
| gi\|52630346\|ref\|NC_006306.1\| | Influenza C virus segment 7, complete sequence | 46 |

Positive and negative controls features are designed against human and mouse house-keeping genes such as actin, GAPDH, and other housekeeping genes. The inclusion of human or other mammalian sequences in the microarrays of the invention is within the scope of the invention. Virus microarray detection performance was tested and validated through analysis of reverse transcribed RNA (i.e., cDNA) from FluMist® influenza vaccine. The microarrays and methods were further validated using samples from seven subjects suspected of being infected with the influenza virus.

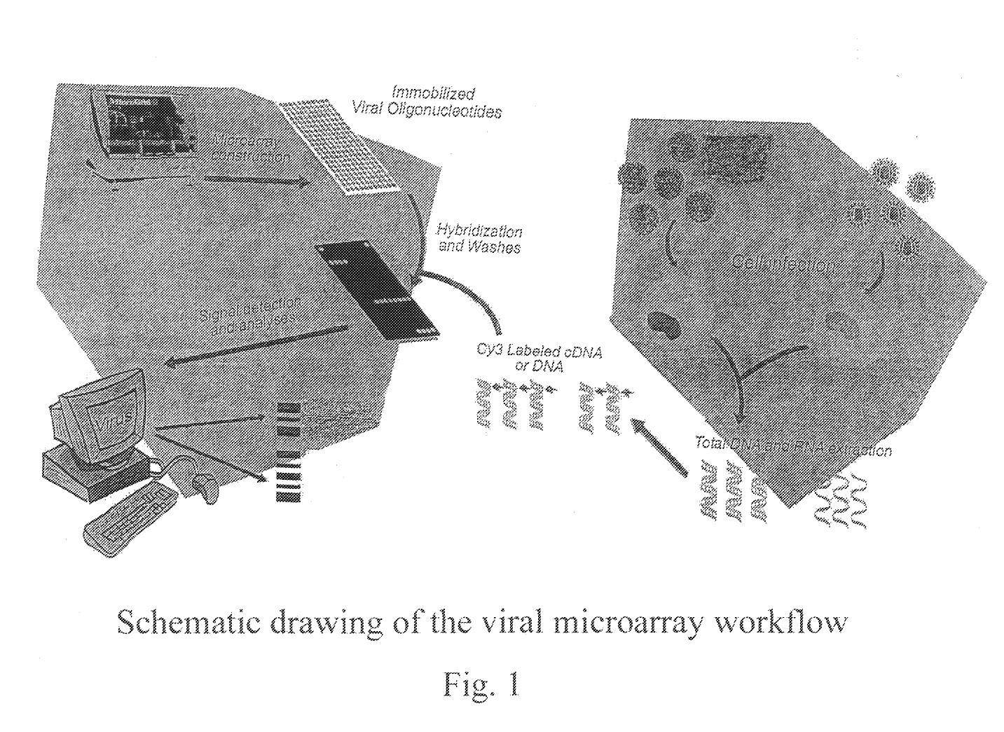

The schematic drawing of the viral microarray technology operation can be seen in FIG. 1. Briefly RNA is isolated from a sample(s) suspected of containing influenza virus and reverse transcribed into DNA. The specific method of RNA isolation and reverse transcription are not limitations of the invention. Such methods can be performed using well known methods or widely available kits (e.g., Qiagen QIAconnect RNA to cDNA Kit). DNA is labeled with fluorescent dye (e.g., Cy3), and hybridized to the microarray. After washing, the microarray is scanned using an Agilent scanner to detect the bound, labeled nucleic acids from the sample. The positions of the fluorescent signals are correlated with specific sequences to which the labeled nucleic acids are hybridized. Results are analyzed using feature analysis program software. The labeled nucleic acids can be physically removed from the support and further analyzed by PCR and/or sequencing to confirm the sequence of the nucleic acid, or to identify new influenza virus strains or mutations within known influenza virus strains.

For the virus array of the invention, as little as 10 ng, about 30 infectious particles, input of either total RNA extracted from samples (e.g., samples obtained from subjects, cell or viral stocks) and reverse transcribed are necessary for the virus to be detected. This technology, enables high-throughput screening that allows detection and identification multiple viruses simultaneously. The microarrays and methods of the invention can be used for detection and identification of viruses in diseases where no particular influenza strain is suspected, for large-scale epidemiological studies, or for any of a number of other purposes such as those discussed herein. The arrays and methods of the invention are ideally suited for the detection of viral recombination due to the breadth of the influenza virus strains included in the array and the inclusion of essentially all sequences to allow for more definitive identification of hybridized viral sequences as compared to detection methods that include only a small number of representative sequences. Moreover, the tiling design method for probes provides redundancy in the system. Therefore, the ability of any one specific probe to bind a viral sequence is not significant in the effectiveness of the microarrays and methods of the invention to allow for the identification of influenza virus nucleic acids. This can allow the detection and identification of viruses from partially degraded samples.

With the viral arrays technology described herein, a diverse range of clinical and research samples can be screened in a high-throughput manner and a large number of samples can be analyzed in parallel on identical arrays. This technology can be very useful for biomedical research and clinical diagnostics. Since this virus microarray can also be used for influenza virus discovery and characterization in birds and pigs, it can be a diagnostic or surveillance tool for the identification of pathological agents responsible for disease outbreaks in farms, feedlots, and egg laying facilities. The microarray can also be used for the detection of viruses in environmental samples (e.g., ponds, fields, nesting areas) that may contain fecal matter from a number of avian species wherein there may be little or no suggestion regarding the specific type of influenza that may be present.

The viral microarray methods include an obtaining nucleotide sequences step, an RNA extraction step, a reverse transcription step, a nucleic acid labeling step, a hybridization step, and a detection step. The methods can further include a sequencing step, and a sequence comparison step using known influenza virus sequence databases to allow for confirmation of the identity of a hybridized sample, or the identification of new viruses.

The obtaining nucleotide sequences step can be carried out using any of a number of or a combination of nucleotide sequence databases, many of which are publicly available. Such databases include, but are not limited to, the National Center for Biotechnology Information (NCBI) nucleotide sequence database, European Molecular Biology Laboratory (EMBL) nucleotide sequence database, and the GenBank sequence database. Searches can be performed using the database based on search terms such as “influenza” to identify sequences for use in the instant invention. Sequences can also be searched for specific characteristics of the sequences (e.g., influenza type, host species). The ability of the database to perform specific functions to manipulate or further sort sequences for specific characteristics is not a requirement of the instant invention. Sequences can also be reviewed manually to select specific sequences with the desired characteristics.

The sequences are used to design tiled n-mer probes that hybridize to the influenza virus nucleotide sequences or the cDNA of the influenza virus nucleotide sequence. Tiled primer design can be readily accomplished by automated or manual method upon selection of a specific n-mer length. The specific methods of tiled n-mer probe design (e.g., automated or manual) and synthesis are not limitations of the instant invention.

The viral RNA extraction from samples can be carried out by a number of methods currently known to one of ordinary skill in the art and optionally using kits that are commercially available. Once total influenza RNA has been extracted and reverse transcribed, all nucleotides from a particular sample are optionally amplified and labeled nucleic acids are prepared with a fluorescent dye, such as Cy3 or Cy5.

The nucleic acid labeling step is performed using a non-specific PCR amplification method. This allows for amplification of all nucleic acid sequences, not just known sequences. This reduces bias for amplification of known sequences allowing for increased detection of a variant sequence or sequences including sequences arising from recombination or mutation of the viral sequence.

In the hybridization step, the test sample containing the reverse transcribed labeled DNA is contacted with an influenza virus microarray. If a labeled DNA derived from sequences present in the test sample hybridizes with (i.e., is sufficiently complementary to) at least one of the plurality of n-mer influenza nucleotide sequences immobilized on the influenza microarray, it is bound to the microarray via that immobilized nucleic acid. In this case, hybridization between the influenza microarray and labeled DNA is detected in the subsequent detection step.

In the detection step, a labeled DNA sequence that is hybridized to the viral microarray is detected. This detection uses known detection methods that can be applied to a microarray method, particularly fluorescence spectroscopy. The use of n-mers capable of hybridizing to substantially all nucleotide sequences of at least one type of influenza virus that infects at least a single host species substantially reduces the need for sequencing or the use of other methods to specifically identify the virus present. The location of the labeled hybridized DNA sequences on the microarray are used to identify the influenza virus present. Following detection and identification, to confirm the identity of the hybridized, labeled DNA, the detected sample labeled DNA can be sequenced and the sequence is compared to viral database sequences.

The term “detection marker”, “detection label”, “detectable label” or other like term as used herein is understood as a tag such as a fluorescent, colormetric, enzymatic, or radioactive tag that can be readily observed by direct or indirect methods such as microscopy and/or exposure to film or other recording device such as a scanner. In a preferred embodiment of the invention, fluorescent tags are used. Fluorescent tags include, but are not limited to, Cy3, Cy5, Cy5.5, fluorescence, rhodamine, SYBR green, Texas Red, DyLight Reactive Dyes and Conjugates including DyLight 488, 549, 649, 680 and 800 Reactive Dyes, Alexa Dyes (Alexa 488, Alexa 546, Alexa 555, Alexa 647, Alexa 680) and IRDye 800. Nucleic acids are preferably labeled with detectable labels using modified nucleotide analogs including detectable labels. Alternatively, nucleic acids can be labeled using nucleotide analogs including groups that are the first half of a binding pair, such as biotin, to be reacted with a detectable label attached to the other half of the binding pair, such as strepavidin. Such nucleotide analog reagents are commercially available from a number of sources. “Labeled nucleic acids” are nucleic acids labeled with a detectable label. It is understood that labeling of a nucleic acid of the invention can include incorporation of a label or other modified nucleotide into a new nucleic acid molecule generated by a polymerase using the nucleic acid isolated from the sample as a template.

The term “detection”, “detect,” or variations thereof as used herein is understood to mean looking for a specific indicator of the presence of one or more nucleic acids bound to a specific location on the solid support corresponding to a specific n-mer. The amount of nucleic acid detected can be none, i.e., below the detection limit. The detection limit can depend on a number of factors including the efficiency and specific activity of the label, the tag used, or the number of probes to which the labeled nucleic acid binds. The term “identification,” “identify,” or variations thereof is understood as the correlation of a specific location on the solid support to a specific nucleic acid. A nucleic acid sequence, which corresponds to at least one influenza virus, is identified by correlating the presence of the detectable marker with the predetermined position of the corresponding n-mer on the support. As the specificity of hybridization can be varied, the relative binding to one position on the microarray to another can be determined. The identity of a labeled nucleic acid can be confirmed by removing the nucleic acid from the microarray and subjecting it to other methods such as sequencing or PCR.

The term “nucleic acid sample”, “sample nucleic acid”, or the like as used herein, may include any polymer, including pyrimidine and purine bases, preferably cytosine, thymine, and uracil, and adenine and guanine, respectively. See Lehninger, Principles Of Biochemistry, at 793-800 (Worth Pub. 1982). The sample nucleic acid is preferably a naturally occurring nucleic acid or fragment thereof, or a nucleic acid generated by a biosynthetic method (e.g., reverse transcription) using a naturally occurring nucleic acid or fragment thereof as a template. As used herein, a naturally occurring nucleic acid is understood as a nucleic acid isolated from a biological sample, such as a tissue or bodily fluid of a subject. Alternatively, the sample may be an environmental sample. For example, sample nucleic acids include RNA isolated from a biological sample, cDNA reverse transcribed from an RNA, a nucleic acid polymerization product generated using non-thermostable polymerases (e.g., Klenow, to generate labeled nucleic acids), or a thermostable polymerase (e.g., Taq, to amplify the amount of sample present). Such biosynthetic methods are well known to those skilled in the art and can be used alone or in combination with each other in the methods of the invention. Fragments can be generated by enzymatic methods (e.g., endonucleases), or amplification of less than full-length copies of nucleic acids by polymerases; and mechanical methods (e.g., shearing or sonication). Fragments can also be generated during the process of sample collection and preparation, and during isolation of sample nucleic acids.

“Oligonucleotide”, “n-mer oligonucleotide” and the like refer to a polymeric nucleotides of any length, either ribonucleotides, deoxyribonucleotides or peptide nucleic acids (PNAs), or a combination thereof, that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and are preferably artificially or synthetically produced. The oligonucleotides used in the present invention can be individually prepared by one of ordinary skill in the art, or they may be purchased, since many are commercially-available or can be ordered from companies that perform custom oligonucleotide synthesis.

The term “n-mer” as used herein, refers to an oligomer or polymer that is comprised of a series of monomers, preferably nucleotide monomers. The n-mers of the invention are preferably about 60 to about 70 nucleotides in length; however, other lengths are possible. For example, n-mers can be about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 nucleotides in length.

The term “tiled” as used herein, refers to a series of n-mers that essentially cover the entire sequence of a gene from an influenza virus. For example, a series of 60 nucleotide long n-mer sequences to tile a specific sequence would hybridize to the specific sequence at nucleotides 1-60, 61-120, 121-180, 181-240, 241-300, 301-360, 361-420, 421-480, 481-540, 541-600, 601-660, 661-720, 721-780, 781-840, 841-900, 901-960, 961-1020, 1021-1080, 1081-1140, 1141-1200, 1201-1260, 1261-1320, 1321-1380, 1381-1440, 1441-1500, 1501-1560, 1561-1620, 1621-1680, 1681-1740, 1741-1800, 1801-1860, 1861-1920, 1921-1980, 1981-2040, 2041-2100, 2101-2160, 2161-2220, 2221-2280, 2281-2340, 2341-2300, 2301-2360, etc. It is understood that the tiling can be started at nucleotide 2, 3, 4, 5, 6, 7, 8, etc and the numbering of each segment is shifted up correspondingly. The length of each of the n-mers can be changed such that the n-mers are longer or shorter, correspondingly changing the exact site of hybridization for the n-mers to the specific sequence. Tiling can include overlapping of the n-mers. For example, the n-mers can overlap by about 1, 2, 3, 4, 5, 6, 7, 8, 9, or more nucleotides. Tiling can also include gaps between the sites for hybridization to the target sequence at regular or irregular intervals. For example, a particular n-mer may have a high level of secondary structure or repetitive sequence making it undesirable for use in the microarray of the invention. Such sequences can be excluded from the microarray as long as the tiling of the influenza sequences as a whole includes sequences to hybridize to substantially all nucleotide sequences of at least one type of influenza virus that infects at least a single host species. However, due to the redundancy in the tiling method, it is not required that such n-mers be eliminated. Such variations and modifications are well understood by those of skill in the art.

As used herein, “corresponding to substantially all nucleotide sequences of at least one type of influenza virus that infects at least a single host species” is understood to mean at least 80%, at least 85%, at least 90%, at least 95%, at least 98%, or up to 100% of all known influenza sequences known at the time of filing of the instant application. Less than 100% of all nucleotide sequences known can be a result of not including a number of the complete list of sequences known (e.g., sequences in Table 1 or all available in nucleotide sequence databases as of Nov. 7, 2006). Probes can be targeted to hybridize to the RNA strand, the DNA strand, or a combination of both. To hybridize to 100% of all known influenza sequences at the time of filing, probes can be designed to hybridize to the sequence of the viral RNA strand, the cDNA strand, or a combination of the strands such that substantially each nucleotide position would be hybridized to a probe. For example, if an influenza virus sequence is 240 nucleotides in length, four contiguous 60-mer probes could be designed to tile the sequence to correspond to nucleotides 1-60, 61-120, 121-180, and 181-240 of the sequence of the viral RNA strand. To hybridize to 100% of the 240 nt sequence, two of the probes could hybridize to the sequence of the viral RNA strand, and two could hybridize to the sequence of the cDNA strand. Although probes are not designed to 100% of both strands, sequences are present that “correspond to” the entire sequence. Hybridization of the labeled DNA to a probe corresponding to either strand demonstrates the presence of both strands in the amplified, labeled DNA sample.

Alternatively, less than 100% of all nucleotide sequences known can be a result of not including a fragment or including only a partial sequence of each of the sequences known for example to exclude sequence fragments that have high secondary structure or are highly repetitive or for other reasons of design choice. At least one type of influenza virus refers to Influenza A, Influenza B, or Influenza C. At least a single host species refers to influenza viruses that have been demonstrated to infect humans, or at least one species of bird, pig, seal, horse, whale. In an embodiment, the microarray includes sequences for at least one type of influenza virus that infects at least all bird species or at least all pig species or at least all horse species or at least all seal species or at least all whale species or the human species. In an embodiment, the microarray includes sequences for at least one type of influenza virus that infects all of at least one sub-family, one family, one sub-order, one order, one class, or one sub-class of bird, pig, horse, seal, or whale.

Modern birds are classified in the subclass Neornithes, which are now known to have evolved into some basic lineages by the end of the Cretaceous. The Neornithes are split into two superorders, the Paleognathae and Neognathae. The basal divergence from the remaining Neognathes was that the Galloanserae, the superorder containing the Anseriformes (ducks, geese, swans and screamers), and the Galliformes (the pheasants, grouse, and their allies, together with the mound builders, and the guans and their allies). Identification and selection of species of birds within this taxonomical structure is well within the ability of those skilled in the art.

Pigs are of the genus Sus and common species is scrofa which includes the subspecies of domestic pig S. s. domestica.

Horses are of the genus Equus, and the common domestic species is caballus.

Humans are of the genus and species Homo sapien.

Whales are from the order Cetacea, which also includes the dolphins and porpoises. The order contains two sub-orders, Mysticeti and Odontoceti, over which the whale species are spread. Identification and selection of species of whales within this taxonomical structure is well within the ability of those skilled in the art.

Seals are from the families of Phocidae (earless seals) and Otariidae (eared seals, sealions). Identification and selection of species of seals within this taxonomical structure is well within the ability of those skilled in the art.

Nucleotide sequences for influenza virus can be identified using a “nucleotide sequence database,” for example, using a “nucleotide sequence database” such as the National Center for Biotechnology Information (NCBI) database (http://www.ncbi.nlm.nih.gov/sites/entrez?db=nuccore), the EMBL nucleotide sequence database (http://www.ebi.ac.uk/embl/), the Genbank database (http://www.ncbi.nlm.nih.gov/Genbank/GenbankSearch.html), or any other private or publicly available databases that include essentially all known sequences of influenza viruses of at least one type. Such databases are well known to those of skill in the art. A search for sequences using the term “influenza” in the NCBI database resulted in the identification of 61,168 nucleotide sequences. Such searches are well within the ability of those skilled in the art to identify influenza sequences of interest. Exemplary sequences are provided in Tables 1 and 2 and in the sequence listing. Information provided with each sequence identified in a nucleotide sequence database identifies the type of influenza virus (A, B, or C) and the host species for the particular viral sequence. Using such nucleotide sequence databases, substantially all nucleotide sequences of at least one type of influenza virus that infects at least a single host species can be readily identified. Sequences can also be compared to identify sequences that may be common between a plurality of members. Such overlapping or consensus sequences can allow for the use of one or more n-mers that correspond to a plurality of influenza virus sequences.

The term “nucleic acid microarray”, “viral microarray”, or “influenza virus microarray” as used herein, refers to an intentionally created collection of n-mer oligonucleotides that can be prepared either synthetically or biosynthetically and can be used to test for hybridization of nucleic acids from samples suspected of containing viral nucleic acids. Sequences for use in the arrays and methods of the invention can be identified using any nucleotide sequence database including substantially all influenza virus sequences. An exemplary list of Accession Numbers of such sequences obtained from the NCBI data base are provided in Table 1. Such arrays can also be screened for hybridization to a labeled nucleic acid sample in a variety of different formats (for example, libraries of soluble molecules; and libraries of oligos tethered to resin beads, silica chips, or other surfaces). Additionally, the term “array” is meant to include those libraries of nucleic acids that can be prepared by spotting nucleic acids of essentially any length (for example, from 1 to about 1000 nucleotide monomers in length) onto a substrate. In a preferred embodiment, the nucleic acids are arrayed in defined positions on a surface or support such that the identity of the nucleic acid can be determined by its position on the surface.

The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “surface,” “solid support,” “support,” and “substrate” as used herein, are used interchangeably and refer to a material or group of materials having a rigid or semi-rigid surface or surfaces such as nitrocellulose, nylon, polyvinylidene difluoride, glass, or plastics, and their derivatives. In the exemplified embodiment the substrate is a glass slide. In many embodiments, at least one surface of the solid support will be substantially flat, although in some embodiments it may be desirable to physically separate synthesis regions for different compounds with, for example, wells, raised regions, pins, etched trenches, or the like. According to other embodiments, support(s) will take the form of beads, resins, gels, microspheres, or other geometric configurations. See, e.g., U.S. Pat. No. 5,744,305 for other exemplary substrates. Technology was developed for making high density DNA microarray (Shalon et al., Genome Research, 1996 July; 6(7): 639645.). The present invention can also employ solid substrates, including arrays in some preferred embodiments. Methods and techniques applicable to polymer (including protein) array synthesis have been described in U.S. Patent Publication No. 20050074787; PCT Publications WO 00/58516, WO 99/36760, WO 01/58593; and U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752. Each patent or publication is incorporated herein by reference. The method of the synthesis of the nucleotides of the array is not a limitation of the invention.

The term “sample” such as a sample from a subject, as used herein includes a tissue or bodily fluid of a subject, such as an animal, mammal, or preferably a human subject. The sample can be obtained from cultured cells, including primary or immortalized cell lines. A sample can include a biopsy or tissue removed during surgical or other procedures. Samples can include frozen samples collected for other purposes. Samples are preferably associated with relevant information such as age, gender, and clinical symptoms present in the subject; source of the sample; and methods of collection and storage of the sample. Sample can be an environmental sample from an area with livestock or wild animals, or a location with humans at which influenza virus could be spread by aerosol or on surfaces such as airports, schools, and office buildings.

The term “bodily fluid” is understood herein to mean any essentially liquid sample obtained from a subject, such as an animal, mammal, or preferably human subject, that may or may not contain cells. If the bodily fluid includes cells, the cells are preferably removed (e.g., by centrifugation or filtration) or extracted prior to contacting the bodily fluid with the microarray. Bodily fluids can include, for example, blood, serum, breast milk, semen, urine, sputum, vomit, and lymph. Bodily fluids are preferably diluted in an appropriate buffer before labeling or contacting the fluid with a microarray.

The term “isolated nucleic acid” as used herein, mean an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods). The term “mixed population” or “complex population” as used herein, refers to any sample containing both desired and undesired nucleic acids. As a non-limiting example, a complex population of nucleic acids may be total genomic DNA, total genomic RNA or a combination thereof. A complex population can also include both viral and host nucleic acids. Moreover, a complex population of nucleic acids may have been enriched for a given population, but also include other undesirable populations. For example, a complex population of nucleic acids may be a sample which has been enriched for desired messenger RNA (mRNA) sequences, but still includes some undesired ribosomal RNA sequences (rRNA). The oligonucleotide spots are preferably isolated nucleic acids.

The term “conserved sequences” or “conserved nucleic acid sequences” refers to nucleic acid sequences that are similar or identical sequences within multiple species or strains of organism, or within different nucleic acid molecules in the same organism. Cross species conservation of nucleic acid sequences typically indicates that a particular sequence may have been maintained by evolution despite speciation. The further back up the phylogenetic tree a particular conserved sequence may occur the more highly conserved it is said to be. Therefore, binding to a conserved nucleic acid sequence typically provides more general information about a sample than binding to a non-conserved sequence. The term “non-conserved sequences” or “non-conserved nucleic acid sequences” refers to nucleic acid sequences that are distinct between multiple species within a genus, and preferably between various viral strains within a species. The degree of conservation of nucleic acid sequences can be determined using any of a number of programs and methods including the BLAST sequence database available through the National Center of Biotechnology Information (NCBI) and ClustalW available through the European Molecular Biology Laboratory-European Bioinformatics Institute (EMBL-EBI). Other alignment tools and methods are known to those in the art.

The term “conditions to allow binding” or “conditions to allow hybridization” is understood herein as buffer, salt, detergent, and temperature conditions that permit specific hybridization of the n-mers with the labeled nucleic acids. Such conditions are well known to those skilled in the art and are discussed, for example in Molecular Cloning: A Laboratory Manual (Maniatis, Cold Spring Harbor Laboratory Press). It is understood that various conditions (i.e., stringencies) of hybridization and washing can be used to modulate the level of complementarity required for the hybridization of the n-mer to the labeled nucleic acid. A single microarray can be washed using progressively more stringent conditions to increase the degree of complementarity between the n-mer and the labeled nucleic acid. Preferred conditions for binding are discussed in the Examples below.

Hybridizations are usually performed under stringent conditions, for example, at a salt concentration of no more than 1 M and a temperature of at least 25° C. For example, conditions of 5×SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook et al., Molecular Cloning A laboratory Manual, 2^{nd} Ed., Cold Spring Harbor Press (1989), herein incorporated by reference in its entirety. Conditions of high stringency can also be produced by addition of a denaturant such as formamide. Particularly preferred hybridization conditions comprise: incubation for 12-24 hours at, e.g., 40° C., in 1 M NaCl, 50 mM MES buffer (pH 6.5), 0.5% sodium sarcosine, and 30% formamide.

The term “hybridization conditions” as used herein will typically include salt concentrations of less than about 1M, usually less than about 500 mM, and preferably less than about 200 mM. When the term “effective amount” is used herein, it refers to an amount sufficient to induce a desired result. Hybridization temperatures can be as low as 5° C., but are typically >22° C., more typically >30° C., and preferably >37° C. Longer sequence fragments may require higher hybridization temperatures for specific hybridization. Other factors may affect the stringency of hybridization, including base composition and length of the complementary strands, presence of organic solvents and extent of base mismatching, as a result the combination of parameters is more important than the absolute measure of any one alone. Such considerations are well known and understood by those skilled in the art. Due to the tiling method used for the design of probes for the microarrays of the invention, the optimal conditions for hybridization will be broader than one in which the probes are designed to have similar melting temperatures, for example due to low GC content or secondary structure. This range of optimal hybridization conditions for probes in the microarrays in the invention does not decrease the accuracy or utility of the microarrays of the invention due to the redundancy of the system. Preferred conditions for hybridization are provided in the examples below.

In particular, the hybridization conditions used in the methods of the invention are preferably such that the amount of specific hybridization is maximized while the amount of cross-hybridization or non-specific hybridization is minimized. In those preferred embodiments where target polynucleotides hybridize to oligonucleotide probes, specificity may be maximized by hybridizing at a temperature that is at or near (e.g., within 2° C. or within 5° C.) the melting temperature (“Tₘ”) of the target polynucleotide and probe. The “melting temperature” of any given target polynucleotide to the probe is defined in the art to mean the temperature at which exactly one-half (i.e., 50%) of the target polynucleotide molecules in a sample are bound to the probe. Thus, the melting temperature is the point on the melting curve at which the bound fraction of polynucleotide molecules is 0.5. Due to the tiling method of probe design in the instant invention, the range of Tₘ of the probes will likely be broader than an idealized Tₘ that is a result of selection of a small number of probe sequences to a given target.

Methods for determining the melting temperature of a particular polynucleotide duplex are well known in the art and include, e.g., predicting the melting temperature using well known physical models adapted to experimental data (see, e.g., Santa Lucia, J., 1998, Proc. Natl. Acad. Sci. U.S.A. 95:11460-1465 and the references cited therein). Mathematical algorithms and software for predicting melting temperatures using such models are readily available as described, e.g., by Hyndman et al., 1996, Biotechniques 20:1090-1096. For example, the melting temperature for an RNA/DNA duplex 25 base pairs in length in 1 M salt solution is between about 60 to about 70° C.

The term “hybridization” as used herein, refers to the process in which two single-stranded polynucleotides bind non-covalently to form a stable double-stranded polynucleotide. Triple-stranded hybridization is also theoretically possible, but it not preferred in the methods of the instant invention. The resulting (usually) double-stranded polynucleotide is a “hybrid.” The proportion of the population of polynucleotides that forms stable hybrids is referred to herein as the “degree of hybridization.”

The term “hybridization probe” as used herein, refers to an oligonucleotide capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics. An n-mer of the invention can act as a hybridization probe. The term “hybridizing specifically to” as used herein, refers to the binding, duplexing, or hybridizing of a molecule only to a particular nucleotide sequence or sequences under stringent conditions when that sequence is present in a complex mixture (for example, total cellular) DNA or RNA. It is understood that sequences do not need to be 100% complementary to specifically hybridize.

The term “overlapping probe” as used herein is understood as a series of probes designed by performing, for example, an 8, 9, 10, 11 or 12 basepair “walk,” along a viral sequence. The length of the overlap depends on the length of the n-mers to be designed. The amount of overlap equals the length of the n-mer minus the length of the “step” in the “walk.” Typically overlap is about 40 to about 70 basepairs.

The term “plus strand” or “+ strand” as used herein is understood to be the RNA strand, i.e., the viral sequences. “Minus strand” or “− strand” as used herein is understood to be the cDNA strand complementary to the RNA viral sequence. Although the influenza virus is an RNA virus, and therefore a single stranded virus, the amplification methods of the invention result in a probe wherein a DNA strand having the same sequence as the RNA is produced, with T's in place of U's, and a cDNA strand to the viral RNA strand is produced.

The term “target” as used herein refers to a molecule that has an affinity for a given probe. For example, a nucleic acid hybridizes, preferably specifically hybridizes, to its target nucleic acid. Targets may be naturally-occurring or man-made molecules. Also, they can be employed in their unaltered state or as aggregates with other species. Targets may be attached, covalently or noncovalently, to a binding member, either directly or via a specific binding substance. Examples of targets that can be employed in the instant invention are nucleic acid molecules including natural and non-natural nucleotides and nucleotide analogs prepared by recombinant or synthetic methods. Nucleotide analogs include nucleotides that can be incorporated into nucleic acid molecules and base pair with a complementary strand. Non-natural nucleotides and nucleotide analogs can include sugar, base, and/or backbone modifications relative to natural nucleotides. Targets are sometimes referred to in the art as anti-probes. As the term targets is used herein, no difference in meaning is intended. A “probe to-target pair” is formed when two macromolecules have combined (e.g., hybridized) through molecular recognition to form a complex.

The term “complementary” as used herein, refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98% to 100%. Percent complementarity can be readily determined by dividing the number of complementary nucleotide pairs over the length of the shorter nucleic acid by the overall length of the shorter nucleic acid. Percent complementarity can also be determined using computer programs such as BLAST available through the NCBI. Methods of determining percent complementarity are well known and understood by those skilled in the art.

Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, e.g., Kanehisa, Nucleic Acids Res. 12:203 (1984), incorporated herein by reference.

The term “monomer” as used herein, refers to any member of the set of molecules that can be joined together to form an oligomer or polymer. The set of monomers useful in the present invention includes, but is not restricted to, for example, nucleic acid polymer synthesis, the set of natural and modified nucleic acids; and (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. As used herein, non-natural nucleotides include nucleotides that have sugar, backbone, or base modifications to alter at least one property of the nucleotide including, but not limited to, stability, affinity for a target or complementary sequence, and/or to provide a new function to the nucleotide polymer such as strepavidin binding by including monomers having a biotin group. Different basic sets of monomers may be used at successive steps in the synthesis of a polymer. The term “monomer” also refers to a chemical subunit that can be combined with a different chemical subunit to form a compound larger than either subunit alone.

The term “viral nucleotides” include sequences identical or complementary to viral sequences, for example from the sequences that from nucleotide sequence databases defined by the GenBank numbers included in Table 1.

The term “obtaining” as in “obtaining a nucleic acid” or “obtaining a sample” refers to purchasing, synthesizing, removing from a subject, or otherwise procuring an agent, sample, or nucleic acid.

The term “subject” refers to an animal, preferably a mammal including a human. A subject is a source for cells, bodily fluids, and/or tissues for the preparation of isolated nucleic acids for use in the methods of the invention. A subject can also be an individual known to be exposed to influenza virus, suspected of having or known to have an influenza virus infection. A subject can be an individual having a predisposition to an influenza virus infection for example due to age or immunocompromised status. Human subjects suspected of or known to have a disease, disorder, or infection can be referred to as “patients.”

The term “diagnosis”, “diagnosing”, and the like are understood to mean to recognize (as a disease) by signs and symptoms a disease or condition in a subject or patient, or to analyze the cause or nature of a problem, particularly a physiological problem. Diagnosis does not require a conclusive indication of disease. Diagnosis can be a process. Identification of one or more influenza virus sequences in a sample from a subject can be used for or contribute to the diagnosis of a disease (i.e., influenza infection).

The term “plurality” is understood to mean more than one.

The terms “a” and “the” are understood to be both singular and plural unless otherwise indicated by context. The term “or” is understood to be inclusive unless otherwise indicated by context.

Ranges are understood to include all of the numbers within the range. For example, 1 to 50 is understood to include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 37, 39, 40, 41, 42, 43, 44, 45, 46, 47, 48, 49, and 50.

The practice of the present invention may also employ conventional biology methods, software, and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, for example, Setubal et al., Introduction to Computational Biology Methods (PWS Publishing Company, Boston, 1997); Salzberg, Searles, Kasif, (Ed.); Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis, Bioinformatics: A Practical Guide for Analysis of Gene and Proteins (Wiley & Sons, Inc., 2.sup.nd ed., 2001). See also, e.g., U.S. Pat. No. 6,420,108.

The present invention may also make use of various computer program products and software for a variety of purposes, such as probe design, management of data, analysis, and instrument operation. See, e.g., U.S. Pat. Nos. 5,593,839, 5,795,716, 5,733,729, 5,974,164, 6,066,454, 6,090,555, 6,185,561, 6,188,783, 6,223,127, 6,229,911 and 6,308,170, each of which is incorporated herein by reference.

Additionally, the present invention may have preferred embodiments that include methods for providing genetic information over networks such as the Internet as shown in U.S. Patent Publications 20030097222; 20020183936; 20030100995; 20030120432; 20040002818; 20040126840; and 2004-0049354 each of which is incorporated herein by reference.

Additional objects, advantages and novel features of the invention will become apparent to those skilled in the art on examination of that described herein, or may be learned by practice of the invention.

### EXAMPLE 1

### Preparation of Labeled DNA Samples from RNA for Use with Microarrays

RNA can be isolated from a sample using any of a number of well-known methods or commercially available kits. The exact method of RNA isolation is not a limitation of the invention.

For example, RNA was isolated from FluMist® (Influenza Virus Vaccine Live, Intranasal; MedImmune Vaccines, Inc) and from human samples including saliva, swabs, and vomit, using a modified version of the viral extraction protocol of Lai and Chambers (Biotechniques, 19:704-706, 1995). The produced viral RNA above plus sex mosquito-borne Flaviviruses RNA were isolated and labeled as described below.

Briefly, 50 mM Tris, pH 7.4 was added to each 500 μl sample. The mixture was incubated 37° C. for 3 hours; then phenol-chloroform extraction was performed, followed by precipitation with of 266 μl of solution of absolute ethanol and sodium acetate (pH 5.3) per 100 μl of sample aqueous layer. The samples were centrifuged at 14,000×g for 15 minutes at 4° C. to pellet the nucleic acids. The pellet was washed with 70% ethanol, dried, and resuspended in water.

For Flavovirus Viral RNA was extracted using Viral Amp (Qiagen, Hilden, Germany), Trizol (Invitrogen, Carlsbad, Calif.) or the MagAttract ViralRNA M48 Kit (Qiagen) in a Genovision GenoM48/BioRobot M48 (Qiagen). Details in Nordstrom H et al 2005.

In parallel, 50 ng of HeLa cell RNA was used as a positive amplification control and water was used for a negative control.

After RNA extraction, RNA was subject to reverse transcription and polymerase chain reaction. Briefly, RNA was reverse transcribed using 40 pmol/μl of a primer 5′-GTT TCC CAG TCA CGA TAN NNN NNN (SEQ ID NO: 47). Second strand synthesis was carried out with 8 units of Sequenase (United States Biochemical). Subsequently, the 30 μl reaction mixture was used as a template for PCR amplification (40 cycles, 30s at 94° C., 30s at 40° C., 30s at 50° C., and 60s at 72° C.) with 100 μmol/μl using the following primer 5′-GTT TCC CAG TCA CGA TC (SEQ ID NO: 48). The use of the mixed primer in combination with the multistep annealing method allows for amplification of essentially all sequences from the cDNA.

A second series of amplification cycles was performed including 20 additional PCR cycles as described above to incorporate aminoallyl-dUTP (Sigma). The aminoallyl containing cDNAs were purified using CyScribe GFX Purification Kit (GE-Amersham) per manufacturer's instructions. Purified products were labeled with n-hydroxyl succinimide (NHS) ester of Cy3 or Cy5 following manufacturer's instructions. Unincorporated nucleotides and fluorophors were removed using CyScribe GFX Purification kit (GE-Amersham). Samples were dried and resuspended in water.

Labeled nucleic acid yield was quantified by spectrophotometric absorbance at wavelengths 550 nm and 650 nm to quantitate the amount of Cy3 or Cy5 present in the sample, respectively.

### EXAMPLE 2

### Preparation of Microarrays

The virus microarray is printed via a contract with Agilent Technologies (Palo Alto, Calif., USA). The 60-mer oligos were synthesized on glass slides using Agilent's non-contact in situ synthesis process of printing 60-mer length oligonucleotide, base-by-base, from digital sequence files. The virus microarray slides contain two arrays where up to 11,000 oligonucleotides per array can be synthesized (2X11K format).

### EXAMPLE 3

### Annealing, Hybridization, and Detection of Labeled Nucleic Acids on Microarrays

Hybridization, washing, and drying of the microarrays was performed essentially according to Agilent instructions with some modifications.

Briefly, 75 μl labeled DNA prepared from DNA or RNA templates was combined with 25 μl human Cot-1 DNA (Invitrogen; placental DNA 50-300 bp in length enriched for repetitive sequences for use as a blocking agent); 25 μl Agilent blocking agent; and 125 μl Agilent 2× hybridization buffer. The mixture was heated to 95° C. for 3 minutes to denature the DNA, and subsequently incubated at 37° C. for 2 hours to allow hybridization of repetitive sequences of the labeled nucleic acid to the Cot-1 DNA. The mixture was centrifuged at 14,000×g to remove any precipitates.

Hybridization was performed in an Agilent hybridization chamber for at least 16 hours in a 65° C. rotating oven at 10 rpm (SciGene, Sunnyvale, Calif.). After hybridization, slides were washed in 5×SSPE, 0.0005% N-laurylsarcosine (SDS); followed by 0.1×SSPE, 0.0005% N-laurylsarcosine (SDS). Washes are preformed at 65° C. An additional wash was performed at room temperature in Agilent stabilizer for 1 minute. Slides were dried and subject to fluorescent detection using an Agilent Microarray Scanner. The presence and concentration of the DNA derived from the virus was independently confirmed and analyzed by conventional PCR.

### EXAMPLE 4

### Detection and Typing/Subtyping of Influenza Viruses in Flu Vaccine Flumist®

To test that the tiling path presented in the array can accurately identify the types and subtypes of influenza, nucleic acid samples from flu vaccine Flumist® were prepared as set forth above and applied to the array. Flumist® consists of three live attenuated influenza viruses that CDC recommends for each year. The 2005 season Flumist® contains two influenza A strains (H1N1 and H3N2) and one influenza B strain.

The array platform reliably detected the presence of all three influenza viruses, each of which is represented by multiple strong positive features for all 8 genome segments. These results also demonstrate that not all features for the influenza genome are positive, suggesting that the tiling array provided necessary redundancy for detection in the events that certain probes fail to perform as expected.

TABLE 3
Detection of Influenza virus in Flumist ®

| | | No. features | | No. features |
|---|---|---|---|---|
| Influenza A | | detected | Influenza B | detected |
| Segment 1 | | 59 | Segment 1 | 66 |
| Segment 2 | | 19 | Segment 2 | 69 |
| Segment 3 | | 63 | Segment 3 | 60 |
| Segment 4 | Subtype HA-1 | 54 | Segment 4 | 54 |
| | Subtype HA-3 | 51 | | |
| Segment 5 | | 45 | Segment 5 | 53 |
| Segment 6 | Subtype NA-1 | 9 | Segment 6 | 48 |
| | Subtype NA-2 | 13 | | |
| Segment 7 | | 30 | Segment 7 | 31 |
| Segment 8 | | 22 | Segment 8 | 29 |

### EXAMPLE 5

### Detection Sensitivity of the Microarray

To evaluate the detection limit of the virus DNA microarray with the RNA label protocol, serially diluted RNA samples from Flumist® were used for the end point dilution test. RNA was isolated from diluted samples, reverse transcribed, labeled, and subjected to analysis using a microarray of the invention and the methods described herein. The microarray correctly and efficiently detected 28-280 virus copies. This corresponds to about 3×10⁻¹⁶ to 3×10⁻¹⁵ g of RNA from Flumist®. The variation in detection of specific sequences was due to variation of the estimated number of virus in the Flumist® vaccine provided by the manufacture.

### EXAMPLE 6

### Detection and Typing/Subtyping of Influenza Viruses in Patients

Swab samples from 7 patients who showed flu symptoms were tested on the microarray of the invention to test the performance of our platform in real world situation. RNA was isolated, reverse transcribed, and the cDNA was labeled using the method above. Each subject was found to be infected with influenza virus. Among these 7 patients, one of them was infected with influenza B virus and 6 of them were infected with influenza A viruses (Table 4).

TABLE 4
result from hybridization pattern with 7 human cold samples

| | influenza type | | |
|---|---|---|---|
| Patient initial | Influeza A | Influenza B | Influenza C |
| S.M. | − | + | − |
| S.T. | + | − | − |
| M.C.M. | + | − | − |
| J.G. | + | − | − |
| R.B. | + | − | − |
| Y.L. | + | − | − |
| C.S. | + | − | − |

+ Positive for this influenza type
− Negative for this influenza type

These data demonstrate that the microarray of the invention can be used to detect and identify influenza virus in subject samples collected by routine methods.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

Lengthy table referenced here
US20090088331A1-20090402-T00001
Please refer to the end of the specification for access instructions.

LENGTHY TABLES
The patent application contains a lengthy table section. A copy of the table is available in electronic form from the USPTO web site (http://seqdata.uspto.gov/?pageRequest=docDetail&DocID=US20090088331A1). An electronic copy of the table will also be available from the USPTO upon request and payment of the fee set forth in 37 CFR 1.19(b)(3).

We claim:

1. A nucleotide microarray comprising a solid support with a plurality of n-mer influenza viral nucleotide segments corresponding to at least 80% of the known sequence of substantially all known influenza virus sequences of at least one type for at least a single host species.

2. The microarray of claim 1, wherein the nucleotide segments correspond to at least 90% of the known genome sequence of substantially all known influenza virus sequences of at least one type for at least a single host species.

3. The microarray of claim 1, wherein the nucleotide segments correspond to 100% of the known genome sequence of substantially all known influenza virus sequences of at least one type for at least a single host species.

4. The microarray of claim 1, wherein the plurality of n-mer viral nucleotide segments are comprised of substantially Type A influenza viruses.

5. The microarray of claim 1, wherein the plurality of n-mer viral nucleotide segments are comprised of substantially Type B influenza viruses.

6. The microarray of claim 1, wherein the plurality of n-mer viral nucleotide segments are comprised of substantially Type C influenza viruses.

7. The microarray of claim 1, wherein the microarray comprises sequences of at least two Types of influenza virus.

8. The microarray of claim 1, wherein the microarray comprises sequences of three Types of influenza virus.

9. The microarray of claim 1, wherein the microarray comprises sequences from two host species.

10. The microarray of claim 1, wherein the host species are selected from the group consisting of at least a single species of bird, human, pig, seal, and whale, the human species, or a combination thereof.

11. The microarray of claim 1, wherein said support is made of materials selected from the group consisting of nitrocellulose, nylon, polyvinylidene difluoride, glass, or plastics, and their derivatives.

12. The microarray of claim 1, wherein the n-mer viral nucleotides are comprised of about 50 to about 80 nucleotides in length.

13. The microarray of claim 1, wherein the n-mer viral nucleotides are comprised of about 60 to about 70 nucleotides in length.

14. The microarray of claim 1, wherein substantially all known influenza virus sequences comprises substantially all known influenza virus sequences available in at least one nucleotide sequence database.

15. The microarray of claim 14, wherein the nucleotide sequence database is selected from the group consisting of National Center of Biotechnology Information sequence database, European Molecular Biology Laboratory sequence database, and GenBank sequence database.

16. The microarray of claim 1, wherein substantially all known influenza virus sequences comprise sequences corresponding to Accession Numbers provided in Table 1.

17. A method for detecting influenza virus in a sample comprising the steps of:
obtaining an array of a plurality of n-mer influenza viral nucleotide segments corresponding to at least 80% of known sequences of substantially all known influenza virus sequences of at least one type for at least a single host species immobilized on a solid support;
labeling the nucleic acid sequences from the sample suspected of containing an influenza virus with a detectable marker;
contacting the labeled nucleic acids from the sample with the solid support with immobilized known n-mer influenza viral nucleotide segments and incubating under conditions to permit hybridization of said labeled nucleic acids thereto; and
detecting hybridization of said labeled nucleic acids.

18. The method of claim 14, wherein the nucleotide segments correspond to at least 90% of known sequence of substantially all known influenza virus sequences of at least one type for at least a single host species.

19. The method of claim 14, wherein the nucleotide segments correspond to 100% of known sequence of substantially all known influenza virus sequences of at least one type for at least a single host species.

20. The method of claim 17, wherein the plurality of n-mer viral nucleotide segments are comprised of Type A influenza viruses.

21. The method of claim 17, wherein the plurality of n-mer viral nucleotide segments are comprised of Type B influenza viruses.

22. The method of claim 17, wherein the plurality of n-mer viral nucleotide segments are comprised of Type C influenza viruses.

23. The method of claim 17, wherein the microarray comprises sequences of at least two Types of influenza virus.

24. The method of claim 17, wherein the microarray comprises sequences of three Types of influenza virus.

25. The method of claim 17, wherein the microarray comprises sequences from two host species.

26. The method of claim 17, wherein the host species are selected from the group consisting of at least a single species of bird, human, pig, seal, and whale, human species, or a combination thereof.

27. The method of claim 17, wherein the virus detected is an unknown virus.

28. The method of claim 17, wherein the virus detected is the product of recombination of viral sequences from at least two distinct host species.

29. The method of claim 17, further comprising diagnosing infection in a host from which the sample is obtained.

30. The method of claim 17, wherein the n-mer viral nucleotides are comprised of about 50 to about 80 nucleotides in length.

31. The method of claim 17, wherein the n-mer viral nucleotides are comprised of about 60 to about 70 nucleotides in length.

32. The method of claim 17, further comprising obtaining of the known sequences of substantially all known influenza virus sequences of at least one type for at least a single host species from a nucleotide sequence database.

33. The method of claim 32, wherein the nucleotide sequence database is selected from the group consisting of National Center of Biotechnology Information sequence database, European Molecular Biology Laboratory sequence database, and GenBank sequence database.

34. The method of claim 33, wherein substantially all known influenza virus sequences comprise sequences corresponding to Accession Numbers provided in Table 1.

35. The method of claim 17, wherein the labeled nucleic acid sequences from the sample are labeled using non-specific PCR amplification.

36. The method of claim 17, further comprises analyzing the sequences of the detected hybridized nucleic acids and comparing the sequences with a database to identify the virus sequences present in the sample.

37. The method of claim 17, wherein the method further comprises identification of a variant influenza virus.

38. A method of detecting a variant in influenza virus comprising:
obtaining an array of a plurality of n-mer influenza viral nucleotide segments corresponding to at least 80% of known sequences of substantially all known influenza virus sequences of at least one type for at least a single host species immobilized on a solid support;
labeling the nucleic acid sequences from the sample suspected of containing an influenza virus with a detectable marker;
contacting the labeled nucleic acids from the sample with the solid support with immobilized known n-mer influenza viral nucleotide segments and incubating under conditions to permit hybridization of said labeled nucleic acids thereto;
detecting hybridization of said labeled nucleic acids.

39. The method of claim 38, further comprising analyzing the sequences of the detected hybridized nucleic acids and comparing the sequences with a database to identify a variant in the influenza virus.

40. The method of claim 38, wherein the variant is a recombination or mutation.

41. The method of claim 38, wherein the labeled nucleic acid sequences from the sample are labeled using uses non-specific PCR amplification.
